(19) United States
(12) Patent Application Publication
(10) Pub. No.: US 2009/0019367 A1
(43) Pub. Date: Jan. 15, 2009

(54) APPARATUS, SYSTEM, METHOD, AND COMPUTER PROGRAM PRODUCT FOR COLLABORATION VIA ONE OR MORE NETWORKS

(75) Inventors: Rebecca Cavagnari, Scotts Valley, CA (US); Marshall Moseley, Eugene, OR (US); Sebastian Torf, Aptos, CA (US); Thomas Torf, Aptos, CA (US)

Correspondence Address: Donald L. Bartels;Nixon Peabody LLP, Suite 900, 401 9th Street, N.W., Washington, DC, 20004-2128, US

(73) Assignee: Convenos, LLC, Scotts Valley, CA (US)

(21) Appl. No.: 11/748,446

(22) Filed: May 14, 2007

Related U.S. Application Data
(60) Provisional application No. 60/799,775, filed on May 12, 2006.

(51) Int. Cl. G06F 3/048; G06F 15/16; G06F 17/30; G06N 5/02

(52) U.S. Cl. 715/716; 709/203; 706/47; 715/753; 715/727; 707/100; 709/204; 707/E17.044

(57) ABSTRACT

A collaboration architecture supports virtual meetings, including web conferencing and collaboration. Presence information is aggregated from different types of communication services to provide a generic representation of presence. In one implementation, collaboration lifecycle management is provided to manage meetings over the lifecycle of a project. Audio options include voice over internet protocol (VoIP) and conventional PTSN phone networks, which are supported in one implementation by an audio conferencing server.

### CROSS-REFERENCE TO RELATED APPLICATIONS

The present application claims the benefit of and priority to the provisional patent application “Apparatus, System, Method, and Computer Program Product For Collaboration Via One Or More Networks,” Ser. No. 60/799,775, filed on May 12, 2006 the contents of which are hereby incorporated by reference.

### FIELD OF THE INVENTION

The present invention is generally related to web conferencing. More particularly, the present invention is directed towards systems and tools for people to collaborate.

### BACKGROUND OF THE INVENTION

Internet conferencing services are of increasing interest to conduct meetings using the world wide web (i.e., commonly known as “web-based meetings” or “web-conferencing”). Conventionally, within an enterprise the local client computers (e.g., desktop computers) sit behind the firewall of the enterprise's server. Client software is loaded onto each desktop computer to support Internet meetings. Each person attending the web-based meeting then establishes an Internet connection to the meeting service, which is hosted on an external server of the meeting service.

The conventional web conferencing architecture, however, has numerous drawbacks that make it difficult for people to collaborate effectively. Conventional web-conferencing systems are difficult to use, inconvenient, not open to different platforms and customization, and not as cost-effective as desired. For example, conventional web conferencing products are designed to be used on desktop computers but typically do not support other options, such as a range of mobile devices. Additionally, since a conventional web-conference architecture is designed to be hosted on a server outside of the enterprise firewall, the architecture is limited and may not provide the same degree of security and speed as desired due to the way that content flows between end-users through the external server. For example, one of the performance limitations of conventional web conferencing architectures is that messages must repeatedly traverse enterprise firewalls in order to be routed by the external server.

Conventional web conferencing architectures also have severe limitations in regards to the ability of end-users to instantly set up meetings. Additionally, conventional web conferencing architectures constrain the ways that end-users can collaborate. As a consequence, conventional web conferencing does not have the convenience and features to be a complete collaboration solution.

Therefore, in light of the above described problems, a new collaboration of architecture and collaboration tools were developed to improve the capability of individuals to collaborate.

### SUMMARY OF THE INVENTION

A ‘collaboration platform’ is a collection of software products and services that facilitates collaborative work both between individuals and between organizations and individuals. This invention creates methods and processes for implementing a collaboration platform in terms of its ‘lifecycle,’ coupled with presence information. It incorporates methods and processes for creating, organizing, storing, presenting, auditing, archiving, and reporting on that work. These methods and processes can be used separately or in conjunction with each other in multiple embodiments which include; a system to facilitate conferencing and collaboration; a digital content server to support sharing and archiving of digital content; a system for providing lifecycle management and a collaboration lifecycle methodology; a system for audio management; a method for providing aggregation and management of presence; a method for dynamically moving point-of-presence within a local- or wide-area network; a method for client devices management; and a method for searching, auditing, reporting, and archiving content.

### BRIEF DESCRIPTION OF THE FIGURES

The invention is more fully appreciated in connection with the following detailed description taken in conjunction with the accompanying drawings, in which:

FIGS. 1A and 1B illustrate a collaboration architecture for providing collaboration services in accordance with one embodiment of the present invention;

FIG. 2 illustrates in more detail a portion of the platform architecture in accordance with one embodiment of the present invention;

FIG. 3 illustrates a message view of a client-server architecture in accordance with one embodiment of the present invention;

FIG. 4 illustrates a collaboration lifecycle;

FIG. 5 illustrates a collaboration platform architecture in accordance with one embodiment of the present invention;

FIG. 6 illustrates events in a client server architecture in accordance with one embodiment of the present invention;

FIG. 7 illustrates in more detail platform components in accordance with one embodiment of the present invention;

FIG. 8 illustrates an exemplary configuration in which different types of clients and data sources may be connected in a meeting in accordance with one embodiment of the present invention;

FIG. 9 illustrates an event stage in accordance with one embodiment of the present invention;

FIG. 10 illustrates a collaboration container and component in accordance with one embodiment of the present invention;

FIG. 11 illustrates flows of exemplary events and responses in stages in accordance with one embodiment of the present invention;

FIG. 12 illustrates modules for integrating buddy lists in accordance with one embodiment of the present invention;

FIG. 13 illustrates a process for generating and managing generic buddy lists in accordance with one embodiment of the present invention;

FIG. 14 illustrates in more detail a portion of the process for generating generic buddy lists from the buddy lists of different service providers in accordance with one embodiment of the present invention;

FIG. 15 illustrates the generation of generic buddy lists for different types of services, such as VoIP and instant messaging in accordance with one embodiment of the present invention;

FIG. 16 illustrates a method of grouping buddy list information in accordance with one embodiment of the present invention;

FIG. 17 illustrates a collaborative aware environment in accordance with one embodiment of the present invention;

FIG. 18 illustrates the generation of a generic meeting list in accordance with one embodiment of the present invention;

FIG. 19 illustrates a method for a group to view common web pages in accordance with one embodiment of the present invention;

FIG. 20 illustrates a method for a group to view secure web pages in accordance with one embodiment of the present invention;

FIG. 21 illustrates a method for generating action items for a meeting in accordance with one embodiment of the present invention;

FIG. 22 illustrates a method for generating blogs for a meeting in accordance with one embodiment of the present invention;

FIG. 23 illustrates presence information and dynamic point of presence in accordance with one embodiment of the present invention;

FIG. 24 illustrates components for implementing dynamic point of presence in accordance with one embodiment of the present invention;

FIG. 25 illustrates a universal presence aggregator in accordance with one embodiment of the present invention;

FIGS. 26, 27, and 28 illustrate a digital content platform in accordance with one embodiment of the present invention;

FIG. 29 illustrates an audio conference server in accordance with one embodiment of the present invention;

FIG. 30 is an illustrative screen shot of user interface for a meeting center in accordance with one embodiment of the present invention;

FIGS. 31 and 32 illustrate in more detail portions of the user interface of FIG. 30;

FIG. 33 illustrates a screen shot for an exemplary business meeting in accordance with one embodiment of the present invention;

FIG. 34 illustrates a screen shot of co-browsing for the exemplary business meeting in accordance with one embodiment of the present invention;

FIGS. 35 and 36 are screen shots illustrating sharing of video files for the exemplary business meeting in accordance with one embodiment of the present invention;

FIG. 37 is a screen shot of an example of sharing complex documents for the exemplary business meeting in accordance with one embodiment of the present invention;

FIG. 38 is a screen shot of co-browsing for the exemplary business meeting in accordance with one embodiment of the present invention;

FIG. 39 is a screen shot of a user interface to set up meetings for ongoing, scheduled, and recurring meetings;

FIG. 40 is a screen shot of a calendaring feature to schedule meeting in accordance with one embodiment of the present invention;

FIG. 41 is a screen shot of a user interface to select audio options for a meeting in accordance with one embodiment of the present invention;

FIG. 42 is a screen shot of a user interface to invite contacts to an ongoing, scheduled, or recurring meeting;

FIG. 43 is a screen shot of a user interface illustrating launching of an instant meeting;

FIG. 44 is a screenshot of a user interface illustrating with a list of contacts showing presence and the status of those available to meet;

FIG. 45 is a screenshot illustrating sending out invitations to an instant meeting.

Like reference numerals refer to corresponding parts throughout the several views of the drawings.

### DETAILED DESCRIPTION OF THE INVENTION

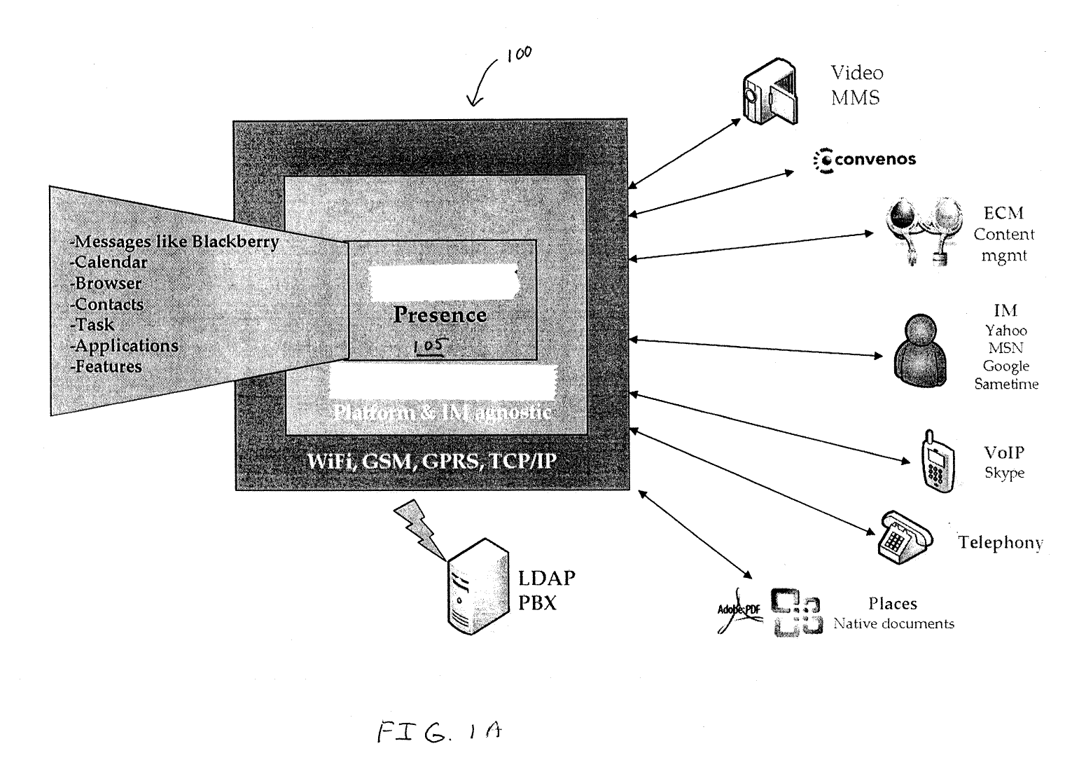

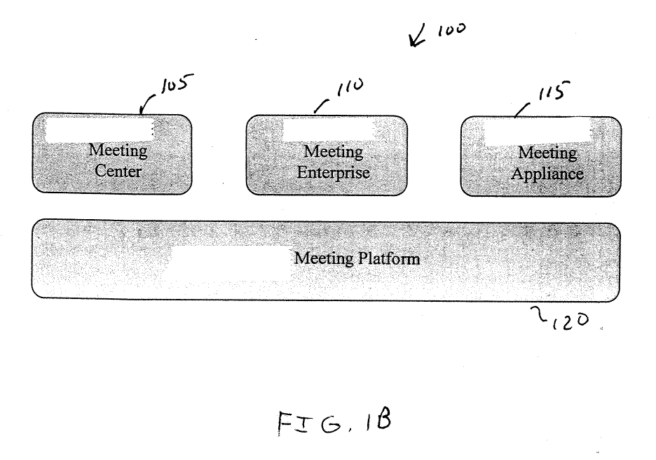

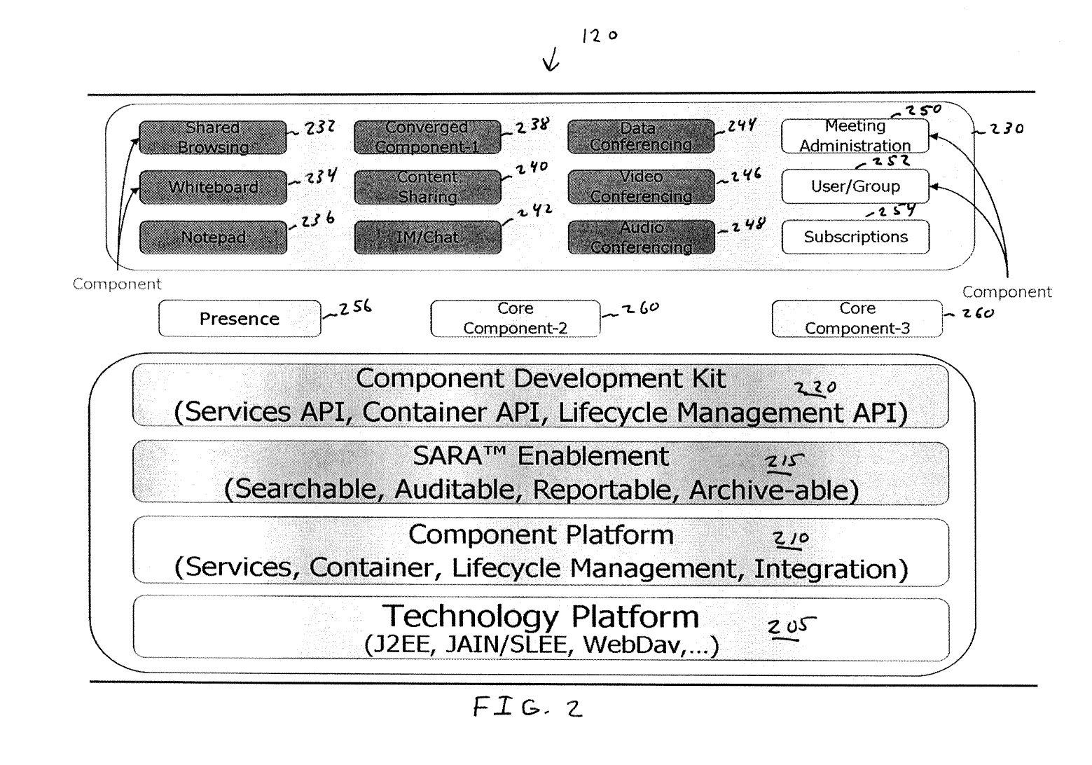

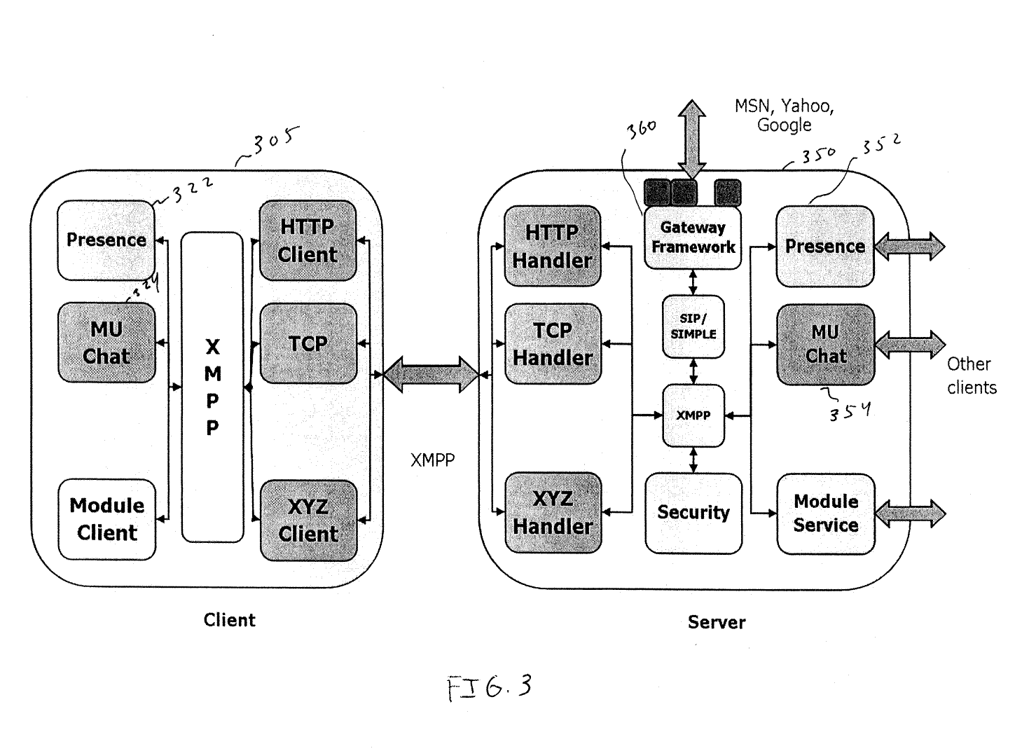

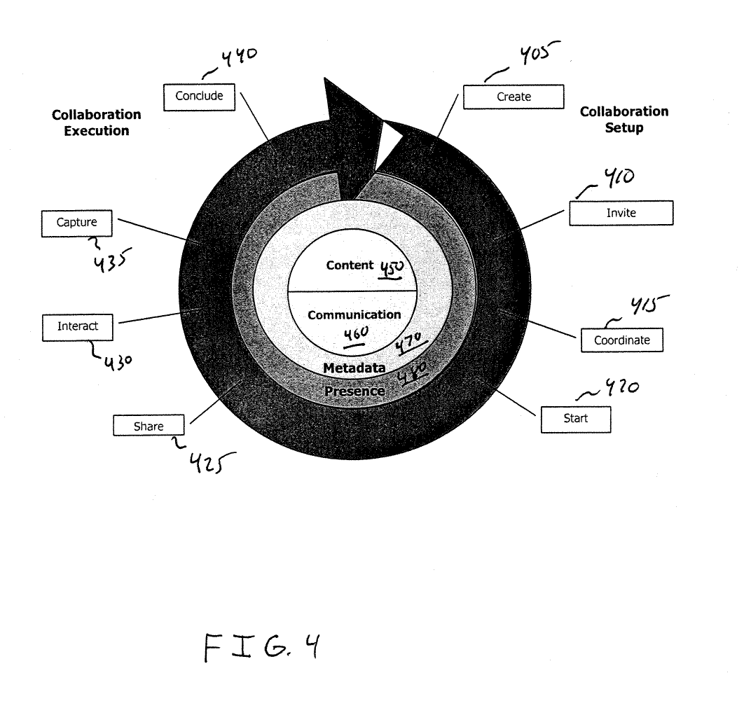

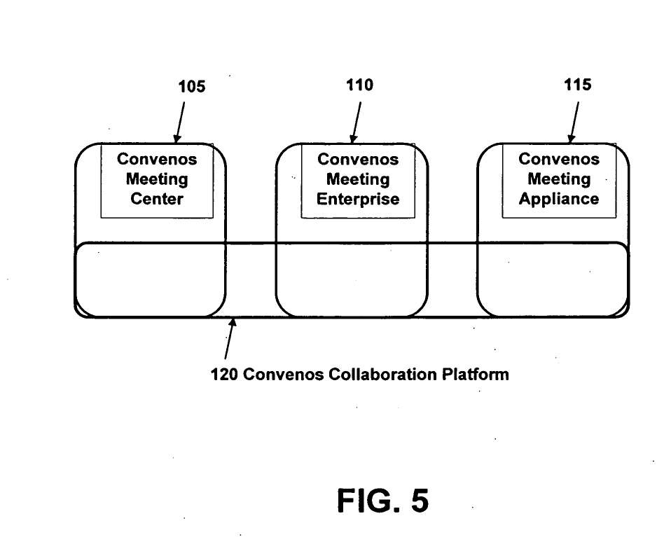

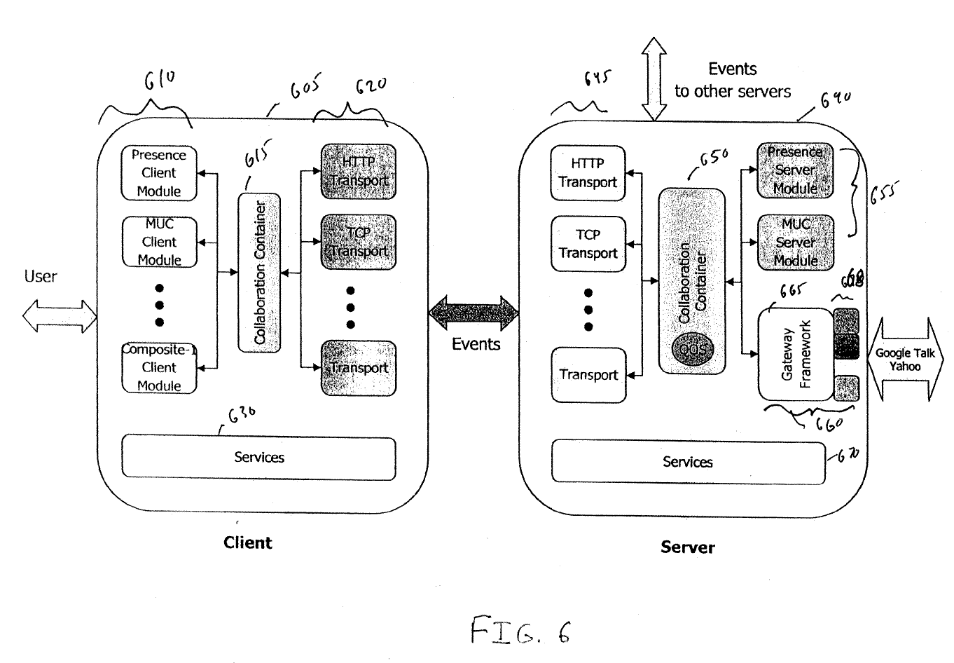

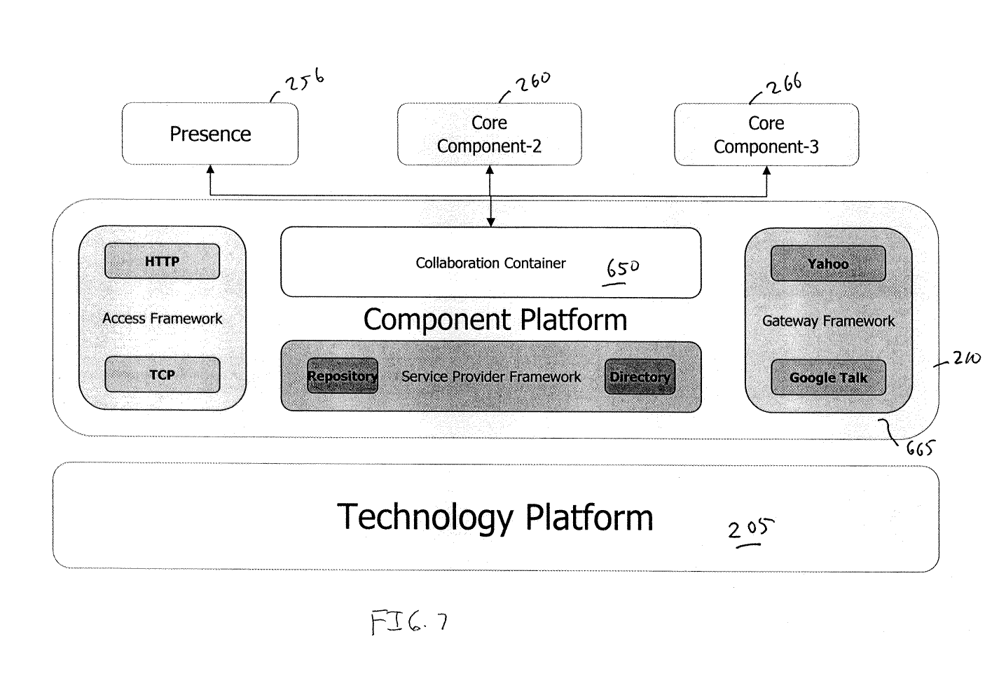

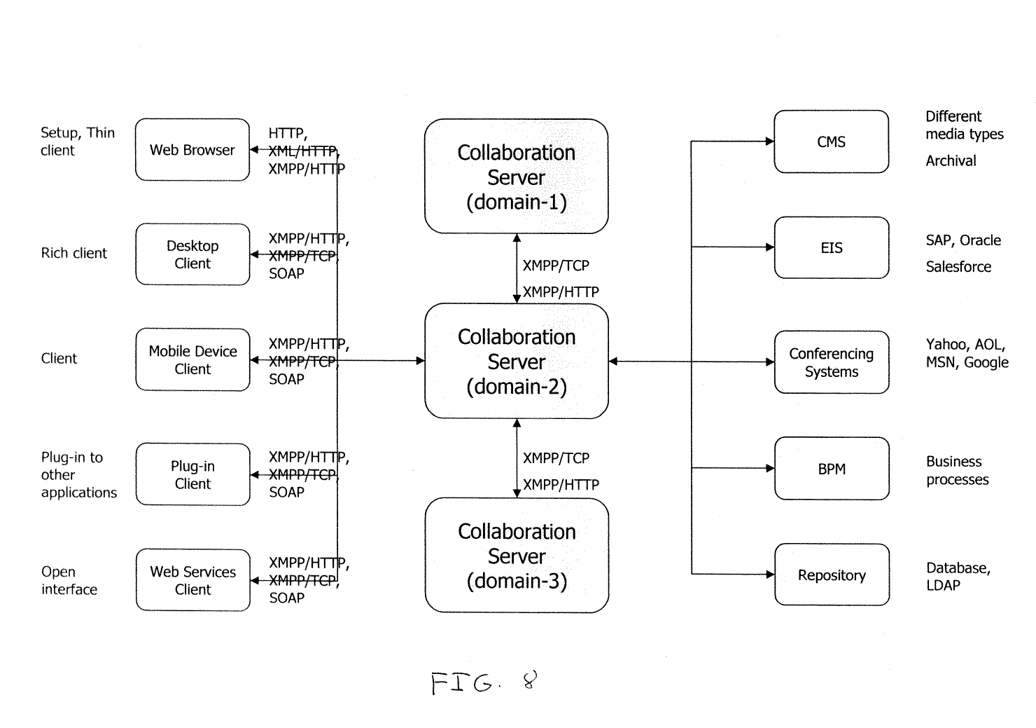

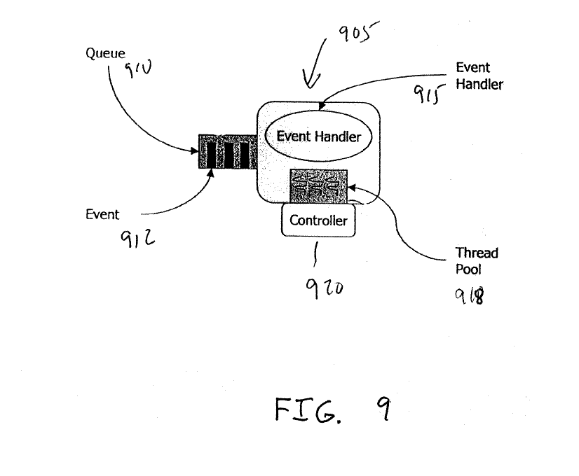

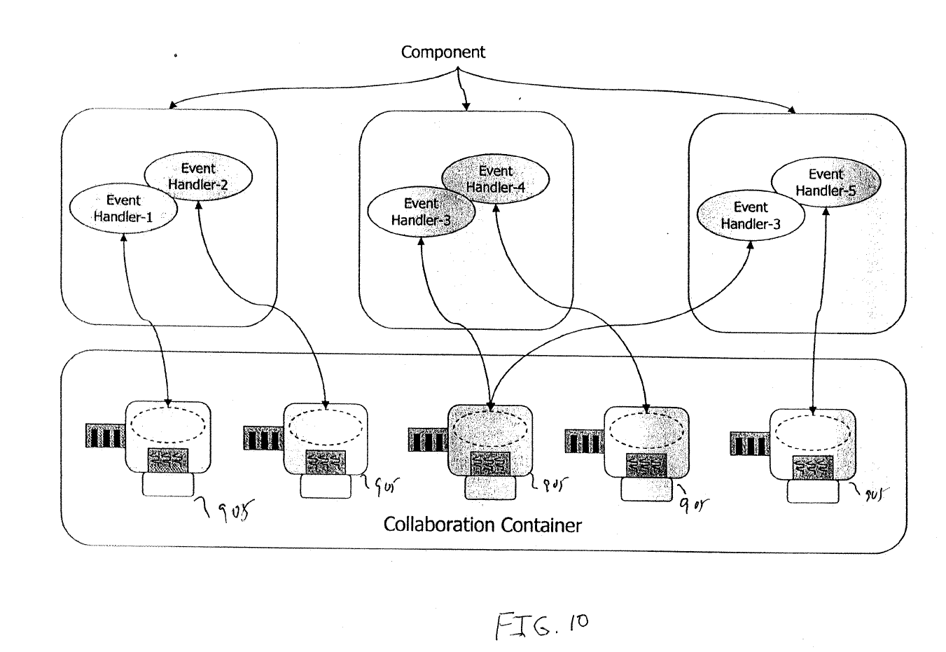

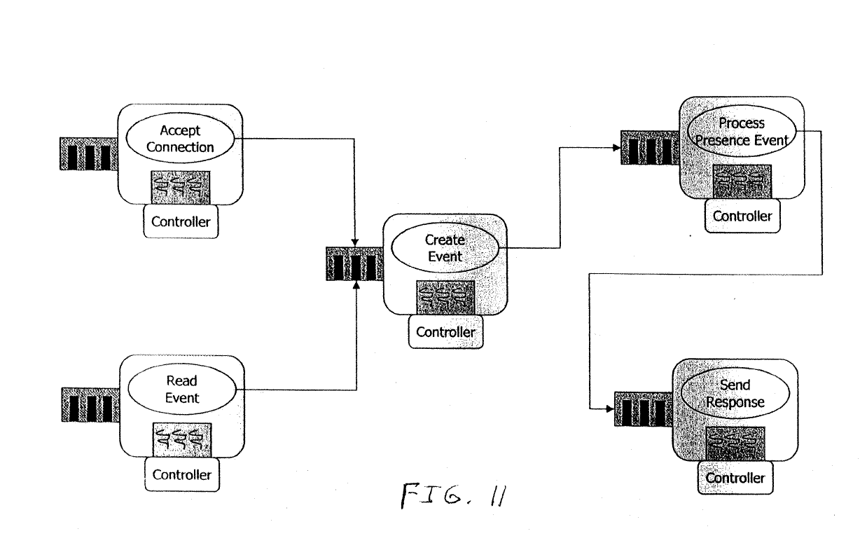

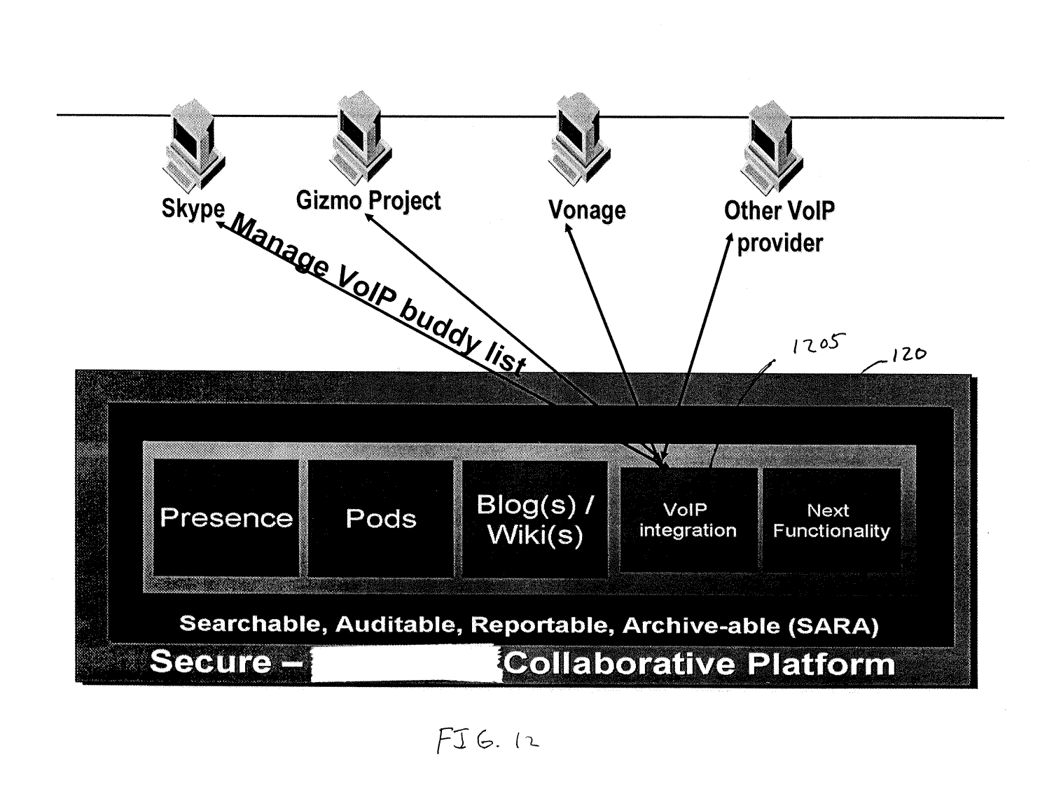

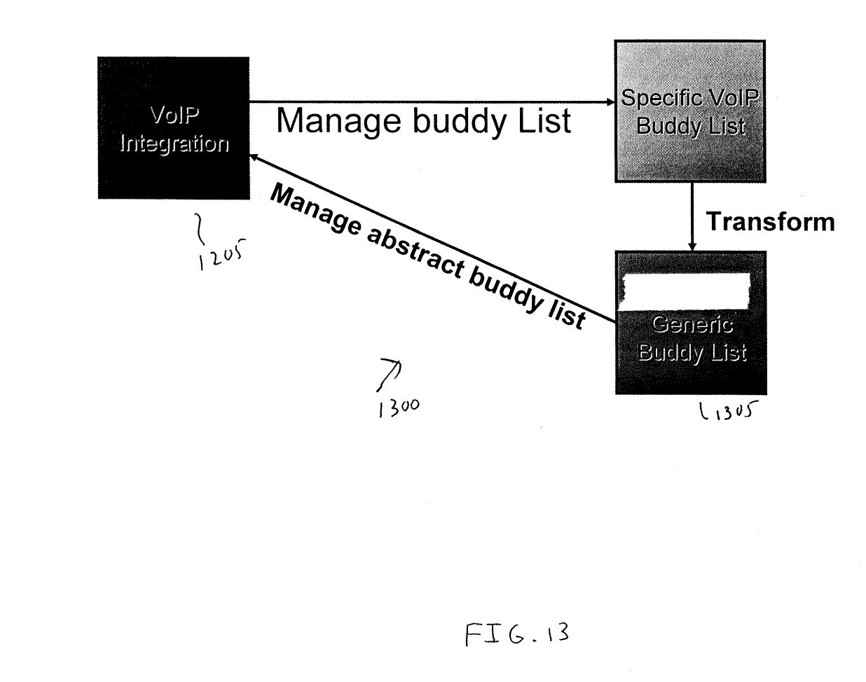

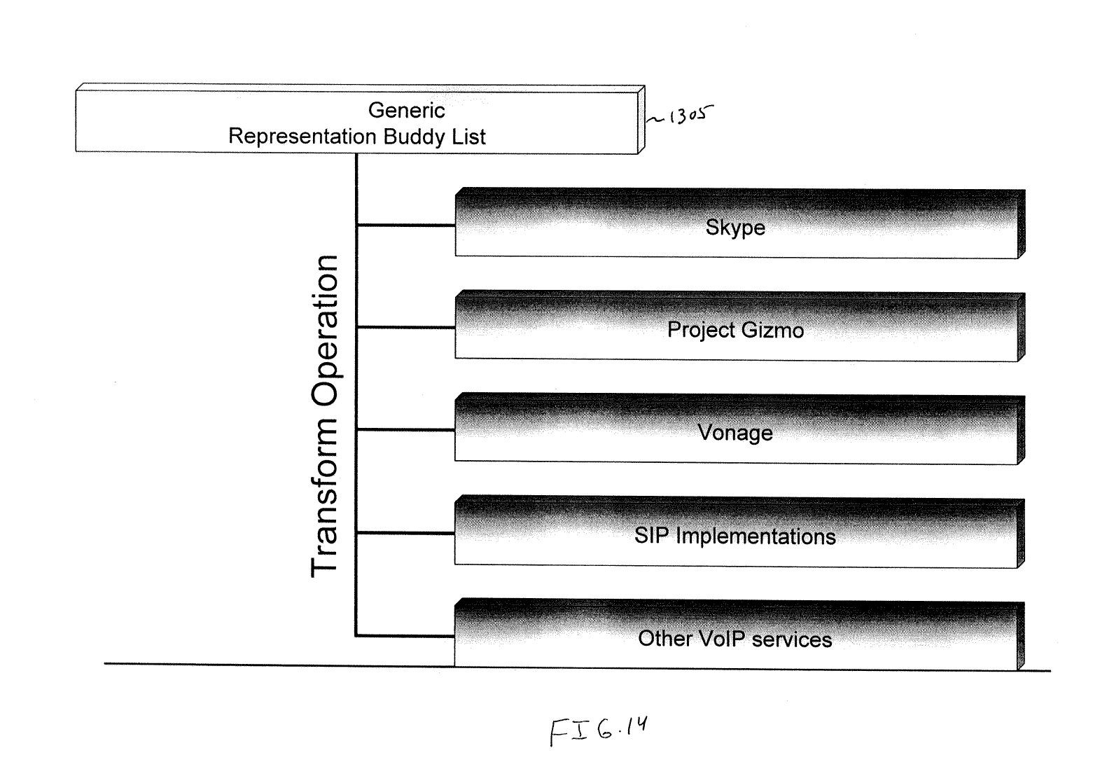

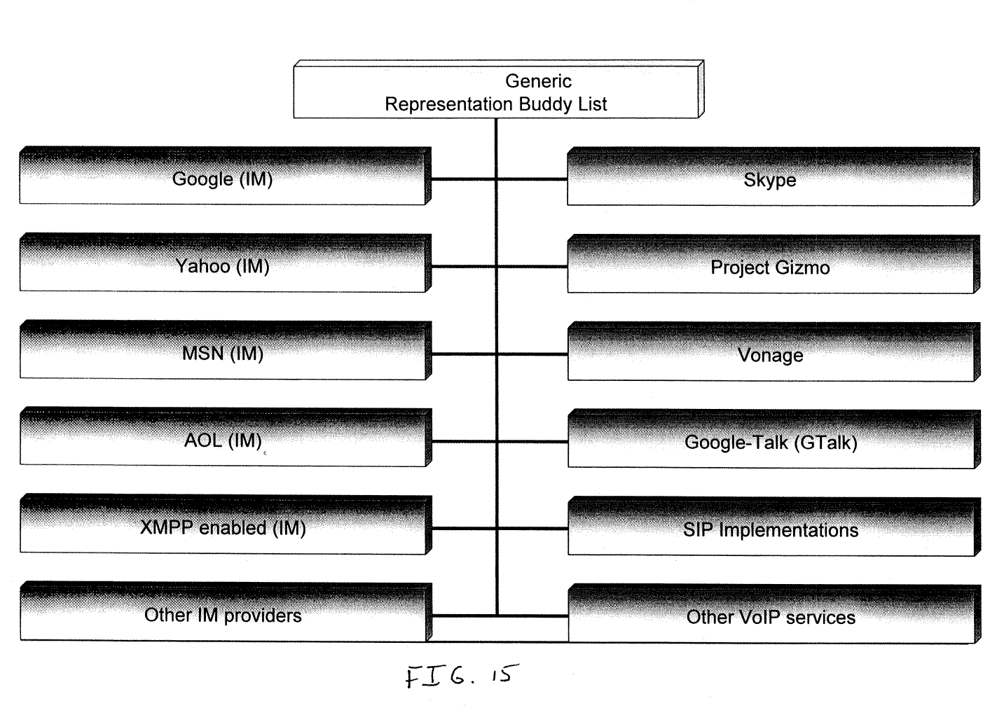

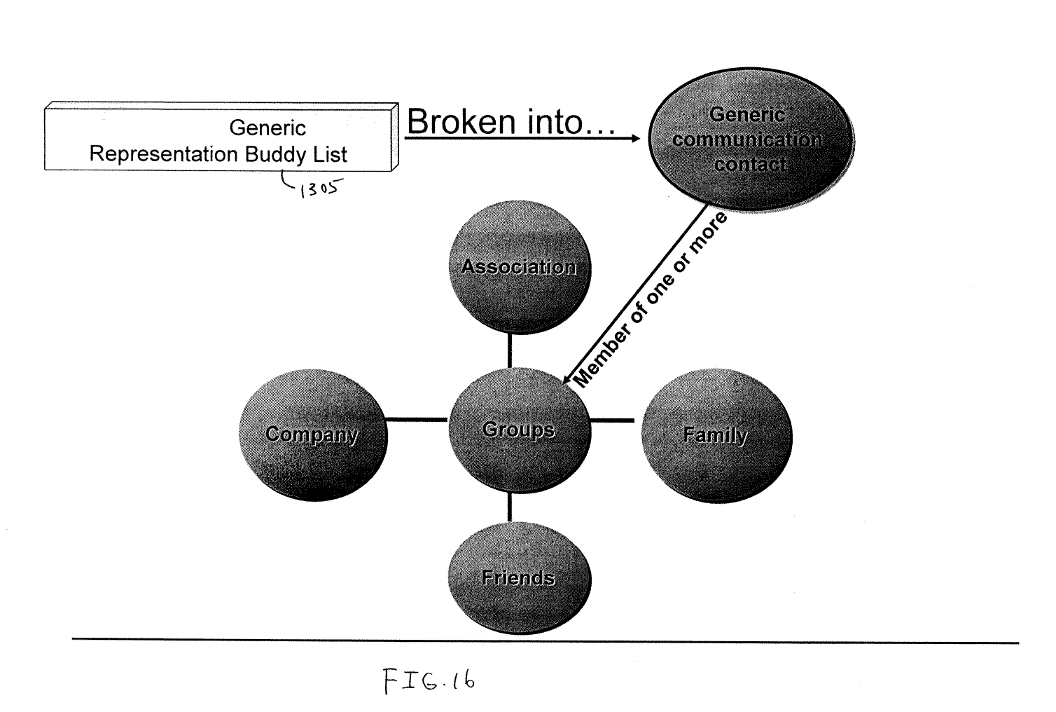

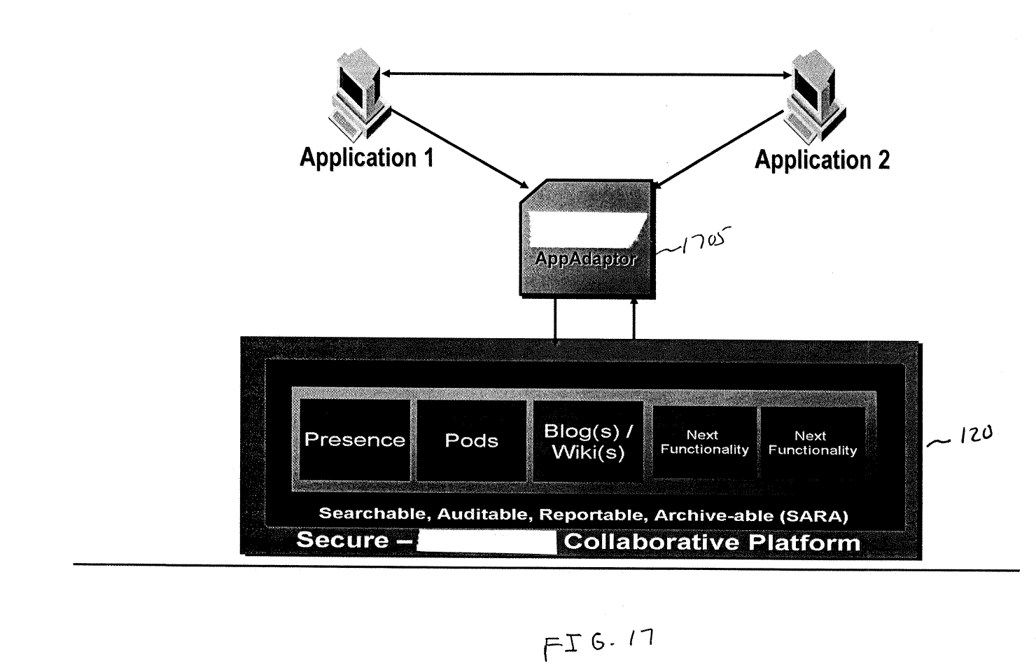

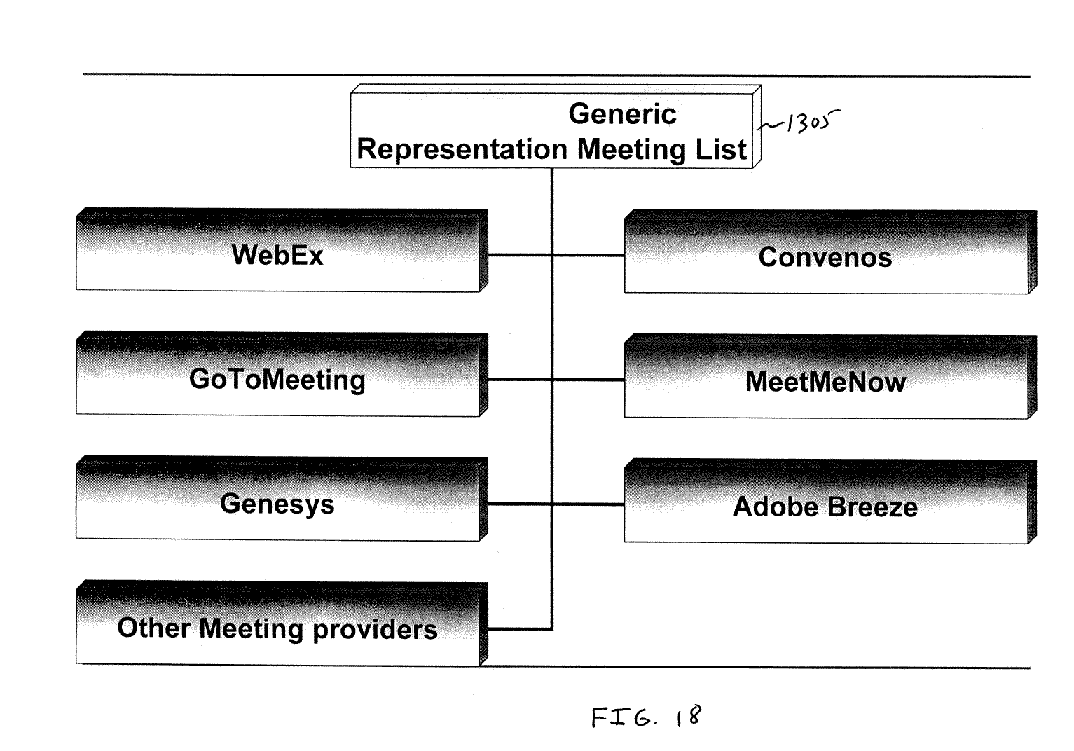

FIG. 1A is a high-level architectural diagram of a collaboration architecture 100 to support conferencing and collaboration. As described below in more detail, while collaboration services may include conventional scheduled online meetings, a variety of collaboration services are preferably supported by the collaboration architecture over an entire collaboration lifecycle. In one embodiment the collaboration architecture includes a presence capability 105. The presence capability is used to generate a status indicator indicating whether and how different users can be reached, such as by telephony, voice over internet protocol (VoIP), instant messaging (IM), or other means and which may be implemented as a status indicator. Other features of the collaboration architecture permit meetings to be established between users having access to different types of client devices or using different platforms or networks, such as telephony, VoIP, and IM. These meetings which are held via different types of client devices or using different platforms and networks can also be described as virtual meetings in that not all of the participants participate in person face-to-face. As illustrated in FIG. 1A, in one embodiment the collaboration architecture also integrates a variety of different applications, tools, and services to facilitate efficient collaboration such as supporting video feeds, access to documents, applications, and content. Additionally, in one embodiment support is provided for messaging, calendaring, co-browsing, using contacts from different sources, tasks managements, sharing of applications, and other features. In a preferred embodiment, the collaboration architecture 100 is platform and IM format agnostic in that it supports different IM protocols and different communication protocols, such as WiFi, GSM, GPRS, and TCP/IP.

Desirable attributes of the collaboration architecture 100 are that it is easy to use, convenient, open, scalable, and cost-effective. Easy to use means a more usable product, not just on the desktop but from all devices from which collaboration is possible. Convenient means that users can collaborate in the context of their activities, so they can focus on what is most important, without having to think about mechanism used to collaborate, and the various tasks needed to setup a collaboration environment. Open standards leads to better integration with other IT systems, whether they are deployed as hosted service or whether they are operated behind the firewall. It also leads to interoperability with other solutions that may emerge in the marketplace, thereby removing any barriers for people to collaborate effectively to make online collaboration possible from anywhere using any device. Scalable means that the solutions will be able to handle the large volume of users, meetings, and content that is expected. By being cost-effective, the solution will be available to everyone, and users will not need to think about the cost of creating and participating in online collaboration activities.

Referring to FIG. 1B, in one embodiment, a basic collaboration architecture 100 includes four main components: A Convenos Meeting Center (CMC) 105, The Convenos Meeting Enterprise (CMC) 110, The Convenos Meeting Appliance (CMA) 115, and the Convenos Meeting Platform (CCP) 120. (Convenos, LLC is the name of the assignee of the present invention and it will therefore be understood that the term “Convenos” is used only for clarity with respect to certain figures of this application such that one of ordinary skill in the art will understand for example, that a Meeting Center. Meeting Appliance, and Collaboration Platform are described.) The Convenos Meeting Center 105 is a hosted service that provides online collaboration and conferencing capabilities to small and medium enterprises as well as individual business users. The Convenos Meeting Enterprise (CME) 110 is a packaged product that provides online collaboration and conferencing capabilities to enterprises within their firewalls and their extranets. The Convenos Meeting Appliance 115 is a plug-and-play appliance that delivers online collaboration and conferencing capabilities to smaller workgroups and enterprise departments.

More specifically, Convenos Meeting Platform 120 is used to deliver the three products as follows. Convenos Meeting Platform 120 is configured/customized and hosted as Convenos Meeting Center 105. For instance, the configuration may include the use of Linux as the OS, MySQL as the database, and a payment application for supporting online subscriptions. Convenos Meeting Platform 120 is configured/customized and delivered as Convenos Meeting Enterprise 110. For example, the configuration here ma include the use of LDAP as the directory server, and adapters to integrate the product with an enterprise Document Management System. Convenos Meeting Platform 120 is configured/customized and packaged as Convenos Meeting Appliance 115. For example, the configuration here may include the hardware packaging needed to deliver this as an appliance.

As described below in more detail, the basic architecture of the platform may be utilized to provide features to improve the capability of user to collaborate. Some of the functions preferably supported by the basic architecture include: presence within the enterprise and across its partnership chain; presence via mobile devices; seamless integration into the enterprise IT ecosystem; centralized control to enforce enterprise policies and procedures; and server side gateways for interoperability with other conferencing systems.

In one embodiment the basic architecture supports a variety of client devices to enable presence everywhere (e.g., via web-phone, mobile device (e.g., a wireless PDA), or platform computer). Presence means that users know whether other users are reachable and in what manner, regardless of the connected client device they may be using. A priority system may, however, be included to determine acceptable meeting times and modes. This permits important meetings to be enabled everywhere such that users will be able to meet other users in the context of a variety of meeting types, using the capabilities of the client device that they have access to.

In one embodiment, server side control is provided. As a result, administrators will be able to control all aspects of the application lifecycle such as deployment, usage, security, and information exchanged through a centralized mechanism.

In one embodiment, rich and usable meeting experiences are supported, based in part on the type of device that an end user utilizes to participate in the meeting. A range of user interfaces is preferably provided. Users will be allowed to use the best interface to participate in meetings.

In one embodiment the basic architecture of the platform is based on an open standards based platform. An open standards architecture facilitates compatibility with different devices and use within an IT ecosystem. Additionally, open standards facilitates interoperability. Users will be able to collaborate with other users as long as they use clients that are based on open standards. No longer will users have to think about the device they have, the client they are using, or the mechanism used for interaction.

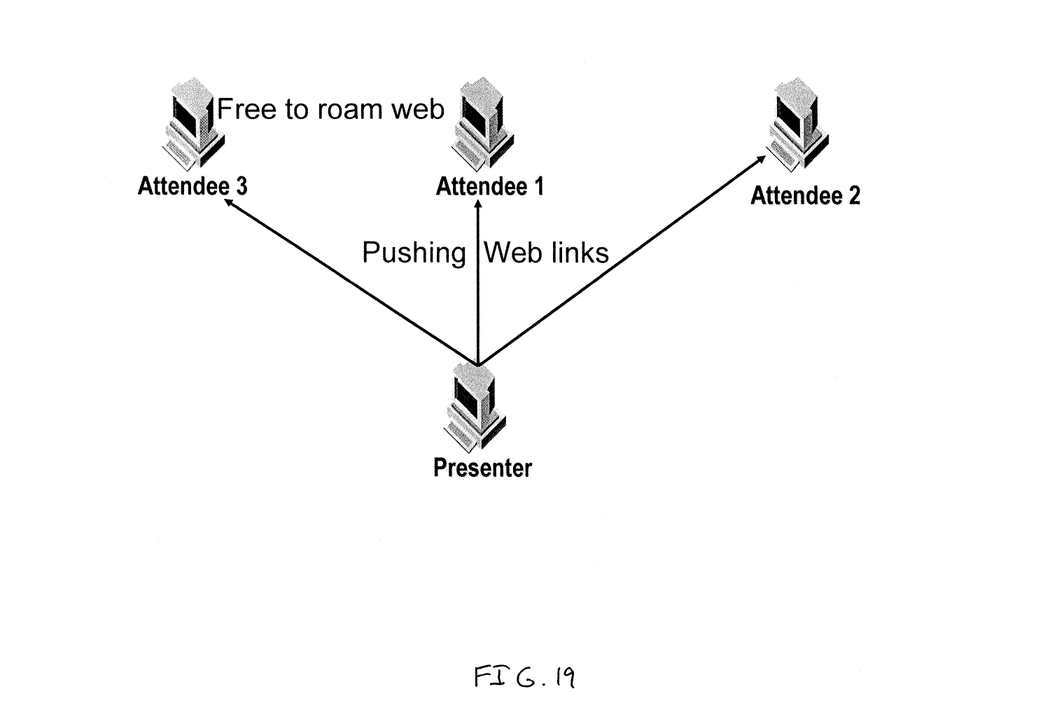

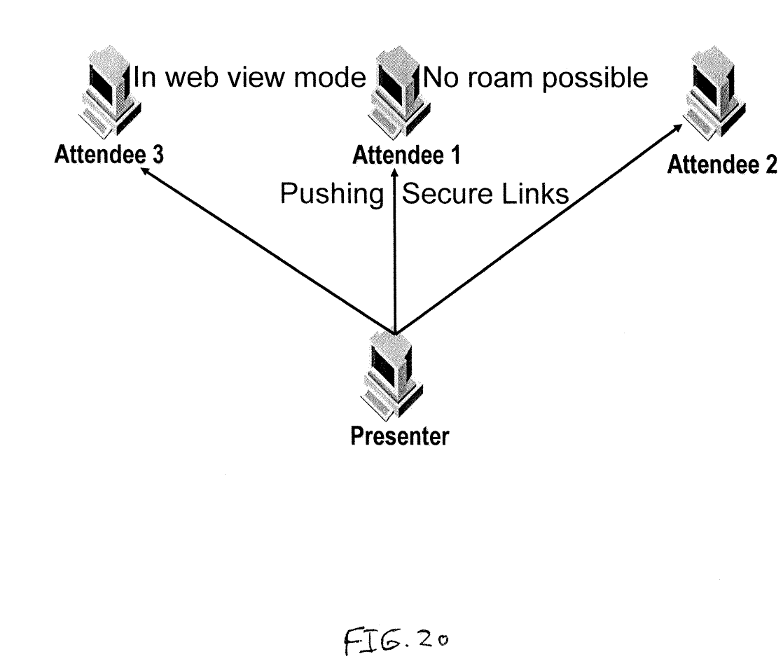

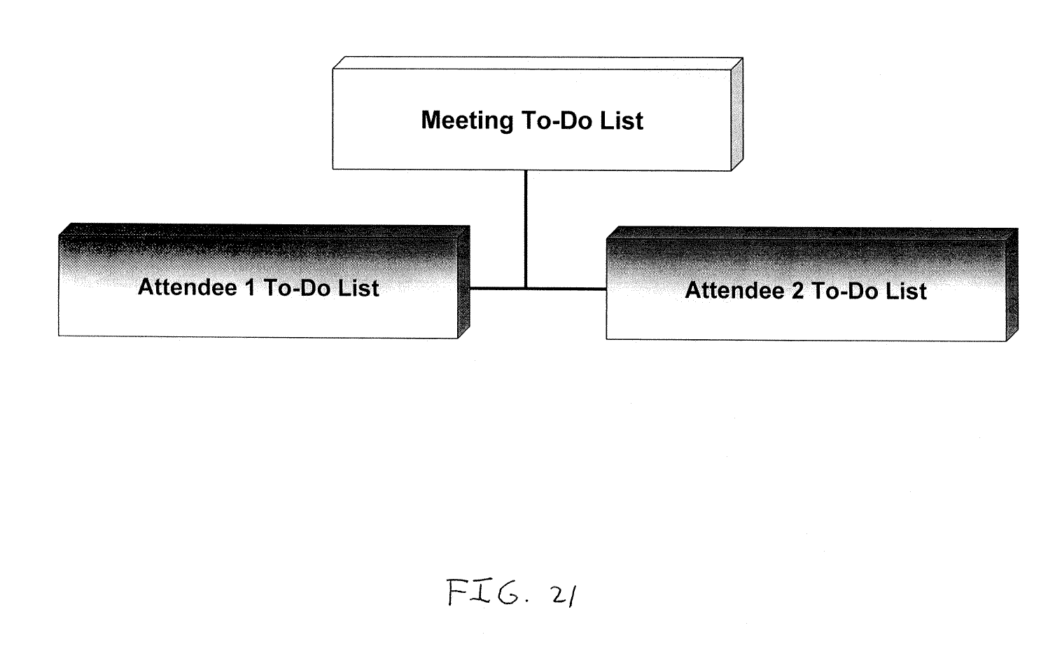

Referring to FIG. 2, in one embodiment the Convenos Meeting Platform 120 comprises a Technology Platform 205 including the core technology components and infrastructure. The Component platform 210 comprises a basic services infrastructure that allows for container management, component licensing, low-level integration framework for communication outside the CMP. The Searchable, Auditable, Reportable, Archive-able (SARA) 215 enablement layer allows for all components that are externalized to inherit key capabilities and functionality, which would include the abilities to search the components data structures, to have auditable routines for verification of the data portion of the components, expose reportable features of the externalized component and finally give the externalized components the ability and knowledge to save themselves to some defined data store. The Component Development Kit 220, provides the functionality to ease the development of components that will be embedded into the Convenos Meeting Platform. The Component Development Kit 220 and Component Platform 210 support Lifecycle Management. Lifestyle Management provides process and supporting tools to manage the entire lifecycle of developing and deploying an application. The Component Platform provides Integration, which includes a framework and adapters that are needed to support the different product versions—CMC, CME, and CMA—for the purposes of integration with systems within the enterprise, and to interoperate with other collaboration products.

An Application Platform 230 provides services needed to develop applications to manage and support all the collaboration activities. An illustrative set of applications are illustrated in FIG. 2, such as Shared Browsing 232, Whiteboard 234, Notepad 236, optional Converged Component 238, Content Sharing 240, IM/Chat 242, Data Conferencing 244, Video Conferencing 246, and Audio Conferencing 248. In one embodiment all of the applications except for meeting administration 250, user/group security 252, and subscriptions/payment 254 are event-driven and used during a meeting. In contrast, payment, meeting administration, and security are transactional applications that are used to manage users and meetings. Presence is supported by presence module 256. In one implementation, presence module 256 generates a status indicator, as described below in more detail.

The basic platform may support a variety of Core Components 260 as part of a web conferencing environment including a suite of communication and collaboration tools to facilitate user interaction, such as dynamic, multi-user, persistent simulated 3D environments: multi-user sharing and interaction to bring people together regardless of physical location, via the Internet; and state-of-the-art real-time 3D graphics, with visual quality and performance to rival that of 3D games; and Internet voice and video conferencing. As other examples, the web conferencing environment may permit users to view multimedia elements and manipulate any object in the virtual world in real-time. For example, a state sharing application may be included to provide the ability for a user to move in the virtual world and interact with other users and things defined in the world. World components may be included as plug-in components that form the structure and behavior of shared worlds and the aural and visual rendering of them. Communication components may be provided to enable direct end-user communications, such as many-to-many voice, text chat, instant messaging, white boards, etc. An Application Framework may be provided to support rapid assembly and customization of clients from plug-in UI components and scripts. Authoring tools may be provided for content authoring and administration tools needed to create and maintain virtual worlds.

In one embodiment the Convenos Meeting Platform 120 supports different types of meetings. Instant Meetings are online meetings that can be created instantly. These are typically short-lived meetings that need to have minimum or zero overhead, so that users can create and participate in them quickly. Scheduled/Recurring Meetings are meetings that are typically held at a time that is known. These can therefore be setup in advance, with either a known set of users or can be setup to be attended by an open invitation. Meeting Places are persistent virtual workspaces that are typically created for a team that needs to interact periodically and needs to share documents, in the context of a project.

In one embodiment, meetings may be created and managed from a browser based user interface or a traditional platform specific client. Both the browser based meeting client and the traditional platform specific client is preferably included that provides the following features for rich online meetings: the ability to see who is in the meeting and their status (i.e., via presence); the ability to share and present documents and slides; the ability to associate file pods, which are groups of files that can be managed and downloaded and associated to either a group or to specific meetings or to 1 or more of the participants; application and desktop sharing; to have native file editing and collaboration, the use of a shared whiteboard; shared browsing; the ability to play rich media, such as video that all participants can experience; a notepad to take notes of the meeting; multi-user chat to exchange text messages with the meeting attendees; single-user (whisper) chat to exchange text messages with a specific user, which others cannot see; and the ability to create, manage, and view the outcome of polls.

A variety of other meeting support features are preferably included to support different types of meetings. For example, support may be provided for scheduled/recurring meetings. Instant meetings are supported by providing a capability to schedule meetings and create instant meetings in context (e.g., from Microsoft Outlook or Microsoft Word). Meeting places are preferably provided with the capability ability to persist information that is shared. A plug-in module may, for example, be included to schedule meetings from Microsoft Outlook or other calendaring solutions available through services on the web (gcalendar, or Microsoft Live calendar).

In one embodiment the basic architecture is designed to work within an IT environment of an enterprise. Referring again to FIG. 1, in one embodiment the basic architecture is based on open standards such as XML, XMPP, SIP/SIMPLE, and WebDAV. The basic architecture may also be designed to be compatible with current generation client devices and also preferably is compatible with all the commercially important devices (e.g. mobile handhelds) from which users are likely to need to collaborate in the future. In one embodiment, the basic architecture supports presence within the enterprise and across its partner network. Other desirable aspects include secure and reliable collaboration and conferencing; centralized control to enforce business policies and procedures (e.g., Sarbanes-Oxley compliance); interoperability with other existing and emerging conferencing applications; platform independence, both on the server side as well as the client side (desktop, mobile devices, etc.); and network independence, such as compatibility with wireless, wireline, and WiFi.

The collaboration architecture may be implemented using conventional software techniques to implement client, server, database, user interface, and support website features. Table 1 illustrates aspects of an exemplary implementation.

TABLE 1
Exemplary Implementation Details of major components

| Architecture | |
|---|---|
| Component | Exemplary Implementation |
| Database | Any JDBC compliant database - Microsoft SQL Server, |
| | Oracle, DB2, MySQL |
| | Portable database schema |
| Website | J2EE/Java |
| | Web application framework for extensibility and |
| | configurability |
| | Any Java supported OS |
| Web UI | Any browser supporting HTML/JavaScript/AJAX |
| Meeting | J2EE/Java |
| Server | Any Java supported OS (Java/J2EE/JAIN-JSLEE) |
| Meeting | Desktop - Windows, Mac, Linux |
| Client | Handheld - Palm, Symbian, RIM, Windows Mobile |
| Access from | Expose Web Services API |
| other | Microsoft Office 2000+ |
| applications | Adobe Flash/Flex |
| | Add-ins to other applications |
| Application | Leverage an application server such as JBoss, and |
| Platform | architecture styles such as SEDA (Staged Event Driven |
| | Architecture) |

The basic architecture may be used to enable a number of different goals, such as an architecture that is open, interoperable, and extensible, platform agnostic, device agnostic, and network agnostic. Table 2 summarizes architectural features that may be used to support different goals.

TABLE 2
Exemplary Architecture Goals

| Goal | Platform Architectural Aspects To Support Goal |
|---|---|
| Open | Architecture is preferably based on standards, such as |
| | XMPP (and the JEP series), HTTP, LDAP, Web |
| | Services, J2EE, JAIN/JSLEE. Preferably compatible |
| | with emerging standards. |
| Interoper- | Architecture is preferably built to interoperate with other |
| ability | collaboration applications. Interoperability may be |
| | supported in various ways such as enabling applications |
| | to communicate with ‘competing’ applications via server |
| | side gateways, providing an integration framework and |
| | adapters to enable applications to work with |
| | ‘complementing’ applications, such as LDAP servers, |
| | and Document Management Systems. |
| Extensi- | The architecture is preferably extensible to allow third |
| bility | parties to configure, customize, extend and enhance the |
| | products built on this platform. A service provider |
| | approach may be supported comprising an SDK |
| | (Software Development Kit) to extend and configure the |
| | product using the SDK. |
| Platform | The server preferably runs on most platforms and the |
| agnostic | client preferably runs on most desktop and handheld |
| | platforms. Clients are preferably supported on a range of |
| | desktop and mobile operating systems. |
| Device | The platform is preferably designed to support a wide |
| Agnostic | range of end-user devices. As a result, the user will only |
| | be restricted by the capabilities of the device they are |
| | using. The server recognizes the device capabilities and |
| | accommodates their limitations, while not affecting the |
| | experience of users on richer devices or desktops. This |
| | allows all connected devices to participate in a |
| | conference “to the best of their ability.” |
| Network | The platform preferably enables users to interact |
| agnostic | regardless of their means of connecting to a network - |
| | wire line, wireless, LAN, etc. This is achieved through |
| | the use of standard transport layer protocols, and a |
| | resilient messaging infrastructure. |

FIG. 3 is a client-server diagram illustrating a “messaging” view of the collaboration architecture. For illustration purposes, only a single client 305 is illustrated in detail. The client and server include TCP and HTTP modules to support network communications. The client includes modules to support presence 322, and messaging 324 (e.g., chat). The server also includes modules to support presence 352 and a gateway framework 360 to support access to other applications (e.g., web-based applications, such as MSN, Yahoo, and Google).

A messaging protocol framework is included as a framework for exchanging different application messages between users. As illustrated in FIG. 3, in one embodiment the messaging protocol framework is based on XMPP or SIP. For some applications, performance considerations may lead to the framework being used for setting up a session and a separate dedicated protocol for carrying the actual application messages. Exemplary desirable features of a message protocol framework are: simple design; extensible, so it can be extended to carry session setup of all applications, and content messages of most applications; provide the capability for server side control; based on widely used (or rapid growth) protocols with consequences on easily available open source technologies for leverage; interoperable with other protocols; and efficient, and consequently scalable. Exemplary message protocol frameworks include XMPP and SIP. XMMP and SIP are favored by companies like Google, Microsoft, AOL, and Apple. However, XMPP is preferred over SIP due to advantages summarized in Table 3.

TABLE 3
Comparison of two exemplary messaging
protocols, SIP and XMPP.

| Aspect | SIP | XMPP |
|---|---|---|
| Definition | Session Initiated Protocol | .Extensible Messaging and |
| | (SIP) is a protocol to | Presence Protocol (XMPP) |
| | establish sessions | is an open XML based |
| | | protocol for extensible |
| | | instant messaging and |
| | | presence. |
| Simple | Sort of | Yes |
| Extensibility | Limited | Yes |
| Server-side | No | Yes |
| control | | |
| Momentum | Microsoft, AOL, Apple, | Apple, Google, IBM, Sun, |
| | Cisco, IBM, Sun | HP, Intel |
| | | More open source efforts |
| Interoperability | SIP implementations have | Better |
| | interoperability issues due | |
| | to proprietary extensions. | |
| Efficient | Not as much as XMPP | Yes |

It is desirable that the basic architecture be compatible with different end-user devices, browsers, and operating systems in a manner that provides an end-user with the best user experience, is most accessible to the user, extensible, and works seamlessly across network and firewall boundaries. It is difficult using a single approach to support all possible end-users having different browsers, operating systems, and device platforms. However, in practice a limited set of technologies will support an overwhelming majority of users (e.g. >95%). Browser, platform and device independence would therefore be achieved by supporting a selected set of technologies that provides support for a selected set of different technologies (e.g., > 95%). As illustrated in Table 4, four major desktop operating systems account for 96% of all desktop users. As illustrated in Table 5, five major browsers account for 98% of users. Similarly, as illustrated in Tables 6 and 7, the top five handheld PDA OSs and SmartPhone OSs account for almost all users. While the ideal goal would be to leverage one technology platform, the current state of candidate technologies does not lead to this possibility. Even when a technology provides a complete coverage, it will not meet the other goals, such as user experience.

TABLE 4
Statistics on desktop Operating Systems.

| Operating System | Desktop Operating System User Statistics |
|---|---|
| Windows XP | 76% |
| Windows 2000 | 10% |
| Windows 98 | 8% |
| Mac OS | 2% |

TABLE 5
Browser Usage Statistics

| Browser | Browser Usage Statistics |
|---|---|
| Internet Explorer 6.x | 86% |
| FireFox | 6% |
| Internet Explorer 5.x | 4% |
| Safari | 1% |
| Opera | 1% |

TABLE 6
Handheld (PDA) OS Statistics

| Handheld | Handheld (PDA) OS Statistics |
|---|---|
| Windows CE | 46% |
| RIM | 20.8% |
| Palm OS | 20% |
| Symbian | 9.9% |
| Linux | 0.8% |

TABLE 7
SmartPhone OS statistics

| SmartPhone OS | SmartPhone OS Statistics |
|---|---|
| Symbian | 63.2% |
| Linux | 23.3% |
| Palm OS | 4.8% |
| Microsoft (Mobile, CE) | 2.3% |
| RIM | 1.6% |

In one embodiment lifecycle management is supported. Some of the features supported by lifecycle management can be understood by a collaboration lifecycle. The collaboration lifecycle is the entire lifecycle for creating and executing a meeting. The collaboration lifecycle is a good mechanism to describe all the activities that take place during collaboration. At the core, collaboration depends on two key complementary aspects—Content and Communication. First, collaboration requires a communication infrastructure that can carry data, voice and video to support various types of interactions. Second, collaboration requires a source of content that is exchanged between various participants. Content could come from repositories such as databases, applications, device screens, or audio/video input devices and should be editable in native formats. There is an inherent lifecycle to content and should have an auditable sign-off capability, in one embodiment, a full lifecycle is supported.

Collaboration depends on presence. Presence assumes reach-ability; in other words, presence and reach-ability are synonymous. If one is not reachable, they are not present. Using the communication infrastructure, presence information (a type of content) is relayed to interested entities. Collaboration cannot happen if the parties are not present. Presence does not only imply the immediate reach-ability of an entity. It also implies when, in the future, the entity can be reached (i.e., potential availability, such as for the case of an individual who is capable of being reached but who has chosen to be available/unavailable for meetings at certain times). An additional technical feature that keeps presence limited will be handled by a layered presence management system described below in more detail in regards to FIG. 14. This enables users of the various presence systems to manage presence for a centralized location. By achieving the centralized management of presence, templates will be able to be applied across defined groups/buddy lists, (ability to manage presence across multiple presence engines)

When users come together (present at the same time) for a common purpose, a meeting takes place. Meetings can either be instant or scheduled. An instant meeting is, as the name suggests, a meeting where the participants come together immediately (or at the instant of creation). Given the complexity of getting users to come together, these meetings are typically between very few people. For example, in many businesses an instant meeting could be two people one-on-one, but could go up to as many as five. A scheduled meeting is a type of meeting where users come together at a scheduled (future) point in time.

FIG. 4 illustrates an exemplary collaboration lifecycle that may be practice on the collaboration systems/architectures described in this application. The collaboration lifecycle process is defined in several discrete meeting steps, including: Create 405, Invite 410, Coordinate 415, Start 420, Share 425, Interact 430, Capture 435, and Conclude 440. Conceptually, these steps are the collaboration lifecycle, and as part of the collaboration lifecycle system are integrated at all times with content 450, communication 460, and metadata 470. The collaboration lifecycle is classified into those steps used to setup and start a meeting (setup) and those that take place during a meeting (execution). The collaboration lifecycle starts with the creation of a meeting. A meeting can be created by one of the participants of the meeting, or by a system whose purpose is to get users to meet. A good example of the latter is a business process, where one of the activities requires a meeting. Once a meeting is created, participants to a meeting need to be invited. This is immediate for an instant meeting, but requires more interactions for a scheduled meeting. In order for a meeting to take place, users need to coordinate to find the time that best suites them. Once all the participants meet at the time of the meeting, the meeting starts. During a meeting, users share content, interact with each other in various ways and capture things. Content shared includes documents, applications, and screens. Interaction mechanisms may include IM, Chat, Whiteboard, Audio, and Video. Elements captured during a meeting may include content that is shared or used during interactions, annotations, notes, and polls. At the end, the meeting is concluded. Conclusion includes generation of meeting transcripts, publishing of the artifacts captured, notification of next steps (action items, etc.), summary of results and return of control to the initiator of the meeting (activity of business process). In one embodiment, once a meeting is over a new meeting blog is created to allow for advanced interaction and follow-up to be simplified.

While a collaboration is commonly defined as a process involving the interaction between two or more people working together toward a common goal, in the context of FIG. 4, a ‘collaboration’ additionally refers to collaborative work done over a local-area or wide-area network (wired or wireless) via any of a series of devices, such as personal computers, cell phones, PTSN phones, VoIP phones, or any other device that creates a point-of-presence on a network. ‘Presence’ 480 is defined in computing terms as a status indicator that conveys the ability and willingness of a potential communication partner—a computer user, for example—to communicate ‘Point-of-Presence,’ or ‘ POP,’ is the location at which a given user is connected into the network. This can be a physical location, an alias, an IP address, or some other unique identifier. ‘Content’ 450 in this context is any digital data created as a result of collaboration, that is used to accomplish said collaboration, or is necessary to its accomplishment, and is stored and used within a collaboration system.

In the context of a collaboration lifecycle of FIG. 4, collaboration is innately bound up in periodicity—it takes place not only over time, but over time with a series of benchmarks that define and demark the forward movement of that collaboration. Therefore binding time-based triggers to collaboration content such that a user is notified of impending milestones and may interact with that content, creates a collaboration system with an automatically managed and audited lifecycle.

The Collaboration Lifecycle of FIG. 4 will now be discussed in more detail according to a preferred embodiment. There are three elements necessary to collaboration: users who intend to collaborate, content (either pre-existing or potential), and the means to communicate. As collaboration begins, users meet and work with content, either individually or together. The presence 480 information may be used in various ways, such as to determine whom to invite to a meeting, to generate a visual representation of attendees at a meeting, or to show availability outside of a meeting. That content is preferably tagged with the following metadata 470: the user(s) who edited it—the unique identifier for the person in the collaboration system; the time period(s) in which it was worked upon—either a single time stamp or a span of time; and triggers, which are actions to take when the content's state changes, or when some state within the system changes. As the lifecycle progresses from the beginning to the middle to the end, the content 450 and its metadata 470 preferably leave an auditable trail that the collaboration system uses to move the content and any attendant actions through the collaboration lifecycle.

In one embodiment the triggers are instructions for system activity stored concurrent with content and related to that content. In one embodiment of a system, triggers are polled and their instruction compared to any state changes within the system. If the trigger requirement is met—if a state change has occurred and the trigger has an instruction relative to it.—the trigger or some portion of it is executed. Triggers are beneficial because they allow collaboration lifecycle management to be event driven. Further, they allow the lifecycle management to occur unattended, or to bring that management to attention of a person. For example, when all chapters of a collaboratively produced document are complete, the user who worked on it can be automatically notified.

In one embodiment of the collaboration lifecycle system, system events along with content, its metadata, and routing information for, are used to create audits of the collaboration process. Generally, an audit is an evaluation of a person, organization, system, or product. Audits are used to determine the validity and reliability of information, and to provide an assessment of a system's internal functioning. So auditing has a direct relationship to quality control in that audits—financial, computing, or otherwise—are used to implement it.

Once a given collaboration lifecycle is complete, its history is preferably stored in terms of user interactions, events, and content. A lifecycle auditing tool can be used to examine historical lifecycles, auditing their processes for efficiency and results, and producing reports that can be used to assess and modify future collaborative efforts.

It will be understood that the basic platform supports implementations in different client-server configurations. Referring to FIG. 5, in one embodiment the CCP comprises a technology platform, a component platform including service provider and gateway frameworks, and a set of core components, service providers and gateway adapters. The Convenos Meeting Center (CMC) may be implemented as a hosted service that provides online collaboration and conferencing capabilities. It includes components, service providers and gateway adapters specific to a hosted web conferencing product. In one embodiment it is adapted to service small and medium enterprises as well as individual business users. The Convenos Meeting Enterprise (CME) may be implemented as a packaged product that provides online collaboration and conferencing capabilities to enterprises within their firewalls and their extranets. The CMA may be implemented as a plug-and-play appliance that delivers online collaboration and conferencing capabilities to smaller workgroups and enterprise departments, typically in 15 minutes or less. As described below in more detail, the architecture permits third-parties to develop collaboration solutions of their own. Additionally, the architecture improves efficiencies in developing various products with common collaboration elements.

FIG. 6 illustrates in more detail client-server components for implementing a message view. FIG. 7 illustrates in more detail a corresponding Component Platform to support the server which includes an access framework, gateway framework, and service provider framework. The system consists of clients that send events to each other. Events are units of information exchanged between collaborating users.

Referring back to FIG. 6, from a message view, the client-server system experience events. Events are sent between clients through servers. A client connects to a server and sends the event to server based on the destination address. The server either processes the event directly or forwards the event to another server for the destination address. An event includes the destination address to which the event must be delivered, optional source address that identifies where the event originated, and content. The content may be opaque (not understandable by intermediaries), translucent (partly understandable by intermediaries) or transparent (completely understandable by intermediaries). The extent of content transparency enables intermediaries to process events based on their content. For instance events that carry more important content may be assigned a higher priority.

Each user interacts with one or more clients. One client is sufficient when it provides all the modes of interaction needed by the user for collaboration. A good example is a client that provides presence and IM, and the user only needs these for collaboration. Another example where multiple clients are needed is when the user additionally requires audio conferencing, and uses the regular telephone for this mode of interaction. In this example there are 2 clients—one providing presence and IM, and another audio conferencing.

A client 605 consists of client modules 610, a collaboration container 615, transport modules 620, and services 630. Client modules 610 respond to and process user events (keyboard, mouse-click, etc.) and generate appropriate events that need to be sent to one or more users. The collaboration container 615 provides run-time support for these modules, as well as means to route the events between the modules and the appropriate transport module. Transport modules 620 are used to send and receive events over different transport protocols. Services 630 are supporting functionality that is available within the client—for instance, persistence, logging, etc.

A server 640 consists of transport handlers 645, collaboration container 650, server modules 655, gateway 660, and services 670. Transport modules 645 enable the server to receive and send events over different transport protocols. The collaboration container 650 provides run-time support for server modules. A server module 655 consists of processors for a logically related group of events. A gateway 660 provides a mechanism for the server to interact with collaboration servers based on other standards and protocols. The gateway consists of a gateway framework 665 as well as gateway adapters 668 to other collaboration servers. A gateway adapter 668 adapts the protocols supported by another collaboration server to the protocol supported by the collaboration server. Services 670 include the functionality used by other elements in the server, such as persistence, security, logging, etc.

Typically, there is a corresponding server module for each client module. However, it is possible to have composite modules on the client that ‘blend’ events from different server modules. A good example of this is a client module that displays the chat messages from another client, but then also displays the presence information for any user that is mentioned in the chat message.

FIG. 8 illustrates an exemplary collaboration system environment having several different possible clients and servers connected in a meeting. In the illustrated example, mobile devices, desktop devices, web browsers, plug-in clients, and web-services clients are illustrated along with exemplary protocols for communicating through the collaboration server. The collaboration server, in turn, may communicate with different applications and processes to support a meeting, such as different media types, EIS, conventional conferencing systems, BPM, and database repositories. Note that a collaboration server may further be divided into different domains.

The collaboration system can be broadly described by the ecosystem it resides in. Users collaborate using a variety of (access) clients—web browser, desktop clients, mobile devices, and other applications. Collaboration through other applications may be achieved through application plug-ins (e.g. Microsoft Office add-in) or by clients developed by partners and customers using the provided interfaces (e.g., protocols, SDK, etc.).

In one embodiment, users need to have an account in a domain to collaborate. A domain is served by one or more collaboration servers. When a user (sender) sends an event to another user (receiver) in the same domain, the same collaboration server routes the event to the receiver. When a user (sender) sends an event to a user (receiver) in another domain, the sender's server sends the event to the receivers server which then forwards it to the receiver.

As previously described the collaboration architecture is preferably customized for collaboration and conferencing. Referring to FIGS. 8, 9, 10, and 11, in one embodiment run-time services for collaboration components are based on a Staged Event-Driven Architecture (SEDA). This allows for a dynamic runtime environment that will allow for services to be provisioned on-demand. These will fulfill the requirements to handle different conference types, including Voice, Data, Audio, and Web.

Referring to FIG. 9, in one embodiment each service is decomposed into stages separated by queues. A stage 905 consists of a queue 910, thread pool 918, event handler 915, and controller 920. The queue 910 is a data structure that processes events 912 in a FIFO order. The size of the queue is controlled by the configuration of the stage (statically) and by the stage controller (dynamically) at run-time. The thread pool 918 is a pool of threads used to execute event handlers. An event handler 915 handles the events that are delivered to it by a stage. The stage controller 920 controls the various parameters of a stage so as to meet the quality of service (QOS) requirements. The QOS is defined at different levels such as through a meeting template during a meeting, during stage configuration, or during container configuration.

Each stage 905 performs a subset of request processing. The stages are internally event-driven, typically non-blocking (although stages may block when necessary). The queues introduce execution boundaries for isolation and conditioning. Each stage contains a thread pool to drive thread execution. However, threads are not exposed to applications. Dynamic control grows/shrinks thread pools with demand.

FIG. 10 illustrates an exemplary SEDA server architecture comprising a collaboration container 650 having stages 905 that the server is configured with to support collaboration. The collaboration component includes one or more event handlers that are invoked by their corresponding stages. In one embodiment the development of a collaboration component requires four steps. A user first defines the component configuration, which includes the name of the event handler class, any parameters used by the event handlers, any hints to the stage, etc. The user then develops the component to include event handlers for those stages. The user then creates a component package for the component configuration and event handlers. The user then deploys the component package in the server.

FIG. 11 illustrates an event processing flow through a sequence of stages. When deployed, the collaboration container 650 creates the stages as required by the component and instantiates the event handlers. When an event is sent to a stage with a logical name, the container finds the actual stage with that logical name and delivers the event to that stage. An event handler receives and processes an event. During and/or after processing the event handler generates events. These events are then delivered to other stages, either statically or dynamically (by the container). In static delivery, the event handler gets a handle to the stage to which the event must be delivered, and explicitly delivers the event to that stage. In dynamic delivery, the event handler requests the container to deliver the event to the stage with a logical name. The container relays the event to the stage whose actual name is mapped to this logical name. The mappings between actual and logical names are defined in the stage configuration. The main benefit of dynamic delivery is that intermediate stages can be introduced at runtime without changing code.

In one embodiment, an automatic participant locator (not shown) is included. A policy manager could control who and where people needed for urgent meetings can be contacted. In particular, a priority policy could determine the means and times with which particular individuals are invited to join meetings. For example, a weaker policy may restrict the participant locator to just using email/calendar to automatically invite a participant. A more powerful policy (e.g., one provided to the CEO of the company) could allow automatic invitation through several means including email, IM, work phone, home phone, pager, or cell phone.

A variety of messaging systems include buddy lists. A buddy list is a list of contacts (e.g., people) that a user wants to keep track of. A buddy list is typically implemented as a list of contacts, with a proprietary format that depends upon the specific vendor. Thus, an individual contact in a buddy list is an individual representation of an entity inside a buddy list where the representation can vary depending upon the vendor. For example, a buddy list can be used to see a list of people who are available for a communication session. In some implementations, a buddy list also provides information on individuals on the list that are connected and available for a communication session. For example, instant messaging (IM) services and some cell phones include buddy lists. It is therefore desirable in setting up meetings to fully leverage off of buddy lists supported by different devices and service providers.

In one embodiment collaboration is facilitated by including a capability to provide audio links via voice-over-Internet Protocol (VoIP) services. VoIP services provide the benefit of reducing the cost of providing audio communications for meetings. Some VoIP service providers include buddy lists. Currently, each vender has a unique buddy list, which makes it very difficult to share or communicate across multiple vendors with VoIP implementations.

In one embodiment, the system has the capability to consume, and manage disparate VoIP providers' buddy lists. The buddy lists of different VoIP providers are added to an aggregated IM buddy list to allow for single location management across multiple providers. It also allows for communication between different VoIP providers with the use of communication relays.

FIG. 12 illustrates an exemplary Convenos Collaboration Platform (CCP) having a VoIP integration module 1205 for managing VoIP buddy list integration. The integrated buddy list may, in turn, be used as a source of information for a presence module. In many enterprise environments users have access to different types of devices, each of which may have different proprietary buddy lists.

FIG. 13 illustrates a contact skimming process 1300 implemented by a contact skimmer in the VoIP integration module 1205 for skimming, transforming, and generating a generic buddy list 1305. A contact skimmer is provided to accumulate and define the aggregated buddy list through the use of a specific Vendor Profile adaptor (not shown) in the VoIP integration module 1205, which would allow for the contact skimmer to adapt to read the a vendors specific buddy list (i.e., “talk” the specific vendor's language). The contact skimmer retrieves specific buddy lists and transforming them in to individual contact to be held and managed by the CMP. Once the Contact Skimmer has acquired the buddy list from the specific VoIP vendors list it then would transform that list from the specific VoIP Buddy List into the Generic Buddy List 1305. A communication profile adaptor allows for communication between the specific vendor and the CMP, for the use of buddy list retrieval.

FIG. 14 represents the process performed by the contact skimmer as the buddy lists of individual VoIP providers (e.g., Skype, Project Gizmo, Vonage, SIP implementation, other VoIP services) are consumed through the Transform Operation. This Generic Buddy List 1305 generated by aggregating and transforming various buddy lists could then be managed with other contacts being managed by the Convenes Collaboration Platform. The lines in FIG. 14 going from The Generic Representation Buddy List 1305 to the specific VoIP vendors would represent the Contact Skimmer as the buddy lists are consumed as they go through the Transform Operation.

Note that generic buddy lists also facilitate managing presence. Individual buddy lists typically have specific implementations selected by each vendor. As a result different buddy lists do not share common attributes or have a way to intercommunicate. However the generic representation of buddy list facilitates managing presence.

Referring to FIG. 15, the Generic Representation Buddy List 1305 aggregates buddy lists from different VoIP providers and IM providers or other services into a generic representation. The generic buddy list a generic list that hold specific information from other specific vendor buddy lists, which can be managed by the CCP. In one implementation, the generic buddy representation buddy list is configured to retrieve names from specific IM and VoIP vendors and manage the communications and relationships between the proprietary methods of each vendor. Each one of the contacts located inside the Generic Representation Buddy List, could then be associated with any number of groups, which could have an number of possible subgroups, which could be represented as below. Groups could be broken into sub-groups like; Associations, Companies, Families, and Friends. Each one of these groups could be associated with any number of other groups, which gives a 1 to many, inside a many to many relationship. The Generic Representation Buddy List would have the ability to manage all aspects of these contacts and groups. The CCP thus used the generic representation buddy list to enable contacts regardless of the underlying vendor's communications profile. Each communication profile would, for example, include the underlying communication protocol and method of communications for a specific vendor.

Referring to FIG. 16, in one embodiment grouping techniques are used to manage the generic buddy list. At the highest level, the generic buddy list is broken into generic communication contacts. A group has the ability to associate one or more contacts together. By using grouping techniques (such as friends, family, groups, and associations) allows for multiple forms of presence aware applications to be managed from a single server. As an illustrative example, suppose; you have an IRQ, Yahoo. Gmail, Skype, and are also located on a company wide LDAP server. All the listed application allow for presence to be known to that particular application. By managing this from the collaboration server, all presence solutions would be kept up to date through the collaboration management code, which would be directly related to the pre-defined grouping techniques. This would include enterprise templates for additional rules, the dissemination of those rules remotely, and the reporting of the rules use.

Referring to FIG. 17, in one embodiment adaptors are provided to support a collaboration aware environment (CAE). A CAE allows two or more non-connected applications to communicate and adds collaboration through a CAE certified approach. CAE enables multiple disparate applications to communicate in new ways by enabling the use of a collaboration server interface. The AppAdaptor 1705 is a special adaptor that allows one or more adaptors to be used to establish communications and exposure of an underlying architecture. The AppAdapter may be implemented as a container that allows for other adaptors to be added, which allows for communications and also allows for exposure of the underlying functionality exposed by the CCP. The AppAdaptor 1705 allows for communication and exposure of the functionality exposed by the CCP. This adaptor would allow for two different programs with no knowledge of each other to share in a collaborative environment.

Referring to FIG. 18, in one embodiment a meeting aggregator allows for multiple vendor meetings to be displayed inside a meeting tree. The Generic Representation Meeting List is a list that the CCP manages as a list of meetings regardless of the specific vendor's information. The generic representation meeting list gives the ability to publish meetings from any vendors that have meetings. As previously described, conventionally each vendor has an individual meeting list with proprietary feeds. The meeting aggregator allows the system to add meetings (information and context) from different products and publish them inside the meeting aggregator. This provides the ability to add meeting information that could be published through each client via its instant communication capabilities.

Referring to FIG. 19, in one embodiment collaborative web sharing with secure sites is supported. This allows for directed web viewing by a group across any non-secure or secure website. This allows for secure sites to be included in a collaborative web browsing experience. In a first mode of collaborative web sharing for non-secure web sites, the CMC is configured to allow for the Host or Presenter to push web links to all participants. These links are consumed by CMC and the internal browser pushes the link and executes the request. At this point all participants can continue to search from that point; however, if the Host or the Presenter pushes another site, all participants are brought back to the Host or Presenters page. That is, as the presenter browses to a specific location on the web, it pushes the links out to the attendees and they are driven to that site. At that point, each attendee could browse anywhere else they so choose, but as soon as the presenter goes to another site all the attendees would be updated to that specific site. However, secure sites pose a special issue due to the requirement for user names and passwords to access secure site. If the Host or Presenter goes to a secure site where a user name and password is needed, then the viewing may be stopped. Also, in some cases, the Host may not want to share the user name and password with all of the participants of the meeting.

Referring to FIG. 20, in one embodiment, a second mode of operation is provided for secure websites. A WebShare feature is used to turn on View-Share, which would be activated by a button. Webshare provides the ability to browse the web as a group. From this point on the WebShare is acting as a single view from the Presenter or Host, thus allowing the Host or Presenter to have people view secure locations. The participants are in a view only mode. All work is done without the presenters having to do anything. As an illustrative example, for secure sites, the Presenter would enter a secure site, and each of the attendees would automatically go into BrowseView only, which means a limited functionality view of what the presenter is seeing. BrowseView is utilized as a secure viewer to allow secure websites to be browsed. The attendees would not be able to roam or browse from this point, since they are in a view only mode. Additionally, in BrowseView all secure fields like passwords would be blanked out. This would allow for attendees to see inside a secure web location without discovering the contents of secure fields, such as user name and password. Once the presenter leaves the secure website the attendee's functionality returns back to the standard Collaborative web browsing mode.

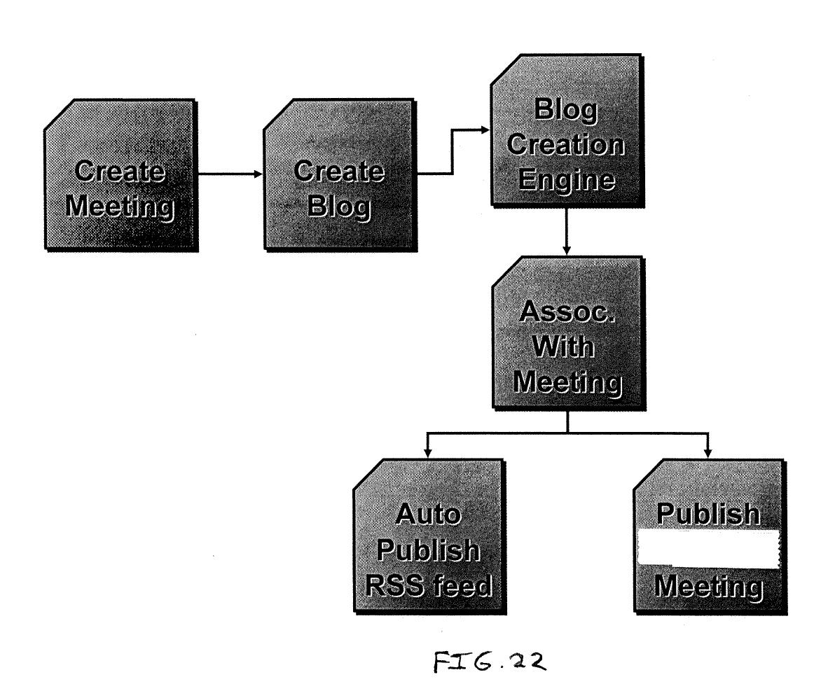

Referring to FIG. 21, in one embodiment action items lists are generated to facilitate calendaring actions items generated as the result of a meeting. In one implementation a master action item list is controlled by a host or presenter and local action items are generated by participants. Each of the lists may be implemented to have a follow-up capability to be added to each user's favorite calendaring or project management tool. This would be done with a single click and an email would be sent each of the assigned tasks. The meeting Action item list is a list that is associated with the particular meeting or Powwow Pod. A Powwow Pod is a specialized distributed files sharing mechanism. During the meeting either a Host or Speaker could add action item(s) to the list and assign them to participants in the meeting. These action item(s) would be pushed to the individual action item, which could be made public or private and would be connected to the participant's calendar programs.

Referring to FIG. 22, in one embodiment web logs (blogs) are generated for meetings for advanced follow-up after the meeting. Once the meeting is over a new Meeting Blog would be created to allow advanced interaction and follow-up to be simplified.

In one implementation, Blog software is modified to work with the defined collaboration groups, participants, and speakers to create an ongoing meeting follow up. It would allow for transcripts, files, and feedback to be located in one convenient location, which may, for example be inside or outside of an enterprise.

In this embodiment the system would automatically create and publish a blog (Web Log) that would be associated with a meeting. This would be done during either the creating or the ending of a meeting. Once the Meeting Blog was created it would be published to both the real simple syndication (RSS) feeds and the Generic Representation Meeting List management system. As previously described, the Generic Representation Meeting list is managed by the platform as a generic list of meetings regardless of the specific vendor's information.

Numerous other extensions and modifications of the architecture are also contemplated. In one embodiment the architecture supports media based exchange of messages from types of applications, such as email, instant messaging, and SMS messages. The gateway architectures support the exchange of messages of various media types without using the same application. For example, the gateway architecture permits a user using an IM application on a desktop to chat with another user who has a smart phone with SMS capability. That is, IM messages from one user are translated by the gateway into SMS messages sent to the user with the smart phone. In one embodiment the user interface displays how a user can be reached by media type (e.g., text, document, graphics, image, audio, or video). As previously described, the platform architecture allows an end user to determine how another user can be reached (e.g., based on the type of device and capabilities of the device). The user can then select the type of media for the meeting and the gateway architecture provides any necessary format conversion. Thus, a user does not need to know the type of application (SMS, IM, etc.) or the mechanism (Yahoo, MSN, etc) through which other users may be reached, only the media types that can be communicated to other users. As an illustrative example, a user may desire to set up a meeting with several other individuals. Using media based exchanges of messages and the presence information of the platform, the user is provided a display of the types of media that different individuals can receive. The user then selects one or more media types that other meeting participants can share. The gateway architecture then performs any necessary conversions.

In one embodiment the architecture supports media translation into different media types. As one example, text messages may be converted to speech for a user who has only a phone for chatting. As another example, text documents may be converted to images for a user who has a local device with image display capabilities but no true text processing capabilities.

In one embodiment, the architecture supports receiving comments on content that is being shared via a plurality of different media types, such as through text annotations, notepad, or chat. The comments may be stored separately from the content, along with a reference to the content and other metadata, such as the person who made the comment or the time the comment was made.

In one embodiment, the architecture supports seamlessly transferring a meeting to different types of devices. In one embodiment, a user specifies different communication addresses of their different devices, either statically or on-the-fly. The communication address may, for example, be an IP address or other communication address (e.g., phone information or wireless device information). The user then selects during a meeting a forwarding communication address and the architecture forwards the meeting session to the device in an appropriate format for the new device. Thus, when a user is participating at a meeting using one type of device (e.g., a phone) they can seamlessly switch to another type of device (e.g., desktop computer) when it makes sense to do so. Since many individuals are available by cell phone or portable wireless device for a portion of the workday, this embodiment permits a user to continuously participate in a meeting and seamlessly switch to the best device available to them at the time. Thus, a meeting could begin at a desktop computer and seamless transition to a cellphone/smartphone (or vice-versa) as a worker enters/leaves the workplace. The automatic meeting transfer is enhanced by the previously described media translation capability.

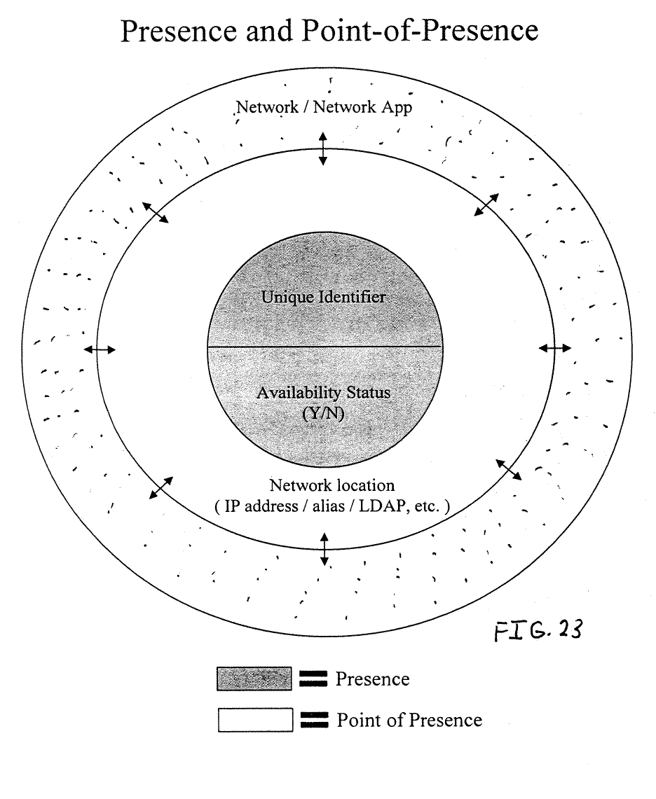

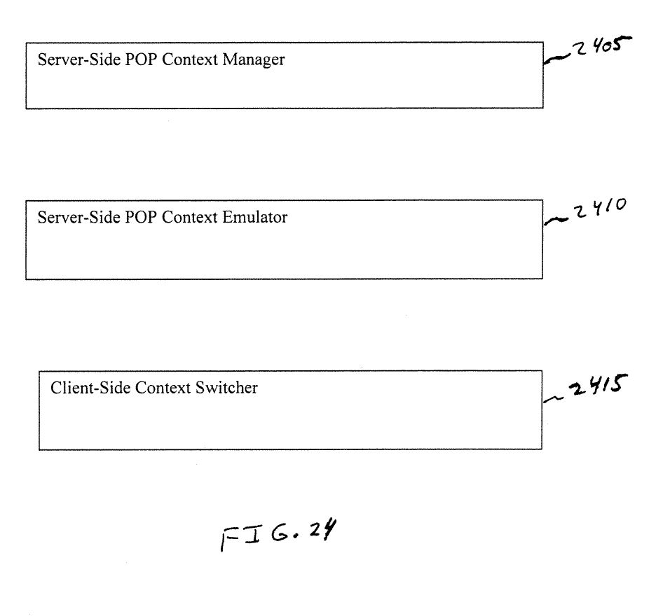

Referring to FIG. 23, in one embodiment presence information includes a unique identifier and an availability status for a contact or group of contacts. That is, presence in this example is the binding of a user's unique identifier to an availability status. The availability status can be a simple yes/no status to indicate that the contact is either available or unavailable. However, more complex forms of profile based presence management are also another option. For example, a profile may be established for each contact that sets roles, times, and groups the contact will be available based on context rules. Additionally, options may be provided for individuals to customize status indicator options, such as away, do not disturb, be right back, offline, invisible, etc. Additionally, the profiles may have rules to specify availability based on device. Moreover, time-based rules may also be included as well (e.g., if a configurable time for which there is no activity at a computer, change indicator to “away” or “away from computer” and/or indicate availability on a backup device). In one implementation, the context rules may specify availability status based on time of day, availability preferences for different devices (e.g., a preference for email versus voice availability in certain contexts), and hierarchical rules that favor a “higher” availability status for certain purposes and times of day (e.g., different availability rules for showing availability based on rules, such as family work relationships to indicate times of availability/unavailability for family members), work relationships (e.g., favoring availability based on a work hierarchy, such as high availability for a high priority project or supervisor). Additionally, note that the profile based presence management may also be applied to groups.

In one embodiment, the point-of-presence may vary. That is, for the case of individuals, the individual may be present through different devices and/or network connections such local and wide-area networks. As a result, the network location and network/network application may vary. Thus, the “point-of-presence” corresponds to an effective network location at which a given presence is found.

In one embodiment, dynamic Point-of-Presence Movement (DPM) between Contexts in Local-area-Networks or Wide-area-Networks is supported. Dynamic point-of-presence movement between contexts in different networks and/or different devices is provided such that a given entity's point-of-presence may shift without effecting the presence status. A combination of server-side and client-side software allows a user to dynamically move their point-of-presence to different contexts without it affecting any action in which that their point-of-presence is engaged. So, for example, if a user were attending a web conference via his or her browser on their laptop, they could dynamically move their presence in that conference to their cell phone without leaving the meeting—their presence status would remain unchanged even though their point-of-presence changes. Thus, in this example if the presence status was used to display a list of meeting attendees participating in the meeting, the list of meeting attendees would remain unchanged even though individual users shifted their point of presence during the meeting. More generally, this concept of maintaining a presence status despite point-of-presence changes may be applied to any action in which a user may engage and is not limited to web conferencing, but may be any collaborative action that has presence information innately bound up in it—instant messaging for example, or telephone conversations, or scheduling. A previously described, “presence’ related to the ability and willingness of a potential communication partner, such as a computer user, to communicate. Presence may be defined in computing terms by a status indicator. The ‘Point-of-Presence,’ or ‘POP,’ is the location at which a given user is connected into the network. This can be a physical location, an alias, an IP address, or some other unique identifier. A ‘Context’ is the mode, method, or device by which the user establishes and maintains presence. For example, one user's context might be that of a wireless smart phone. Another's context might be his or her calendaring software. Yet another might be a laptop computer connected via an Instant Messenger program.

Referring to FIG. 24, in one embodiment. DPM is implemented using at least three components: a Server-side POP context manager 2405, a Server-side POP context emulator 2410, and a client-side context switcher 2415. The server-side POP context manager is a server-based software component. It is the management and arbitration mechanism that integrates the point-of-presence and its context into some collaborative action. The server-side POP context emulator is a server-based software component that will, at the appropriate time, emulate the point-of-presence and its context. The client-side context switcher is a client-based software that accepts and acts upon the user's request to initiate DPM. In a collaboration environment, the server-side POP context manager manages multiple connections with multiple points of presence. A user who wishes to change contexts, to move his/her point of presence to another context—from a laptop to a cell phone, for example—initiates the change in contexts by activating the client-side context switcher. For example, the user may either specifically activate the client-side context switcher, or it may be activated automatically as default when shutting down the context (turning off the laptop, to continue the example.) On the server, the server-side POP context manager first notes the command to change contexts and prepares to do so by starting the server-side POP context emulator. The server-side POP context emulator then takes over the connection with the POP context manager, and whether the connection is session-based or not, appears to the POP context manager as the currently running user, point-of-presence, and context. (Again, to continue the example, it imitates the laptop for a short time.). The user then establishes contact with the POP context manager via the new context. (The cell phone, to continue the example.) The server-side POP context manager then initiates the new point-of-presence with the new context. The server-side POP context manager then terminates its connection to the server-side POP context emulator. Note that the user's point-of-presence and context has moved, but the activity in which the user is engaged is uninterrupted.

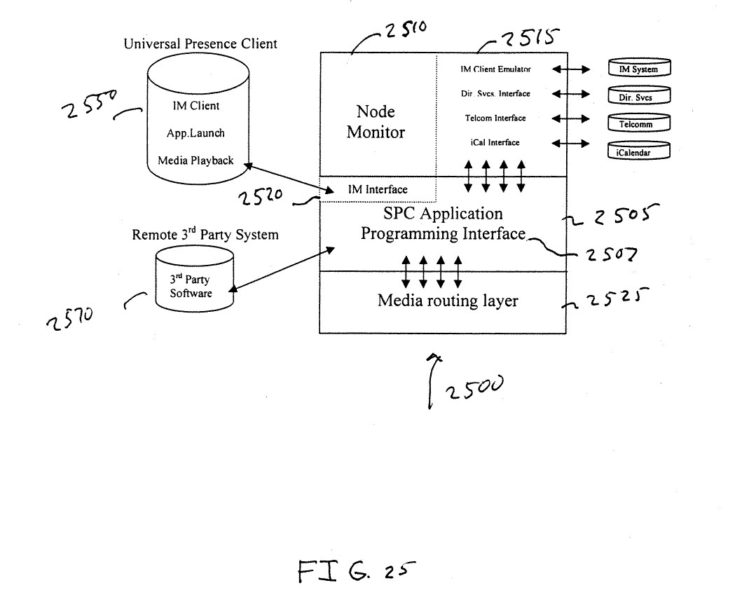

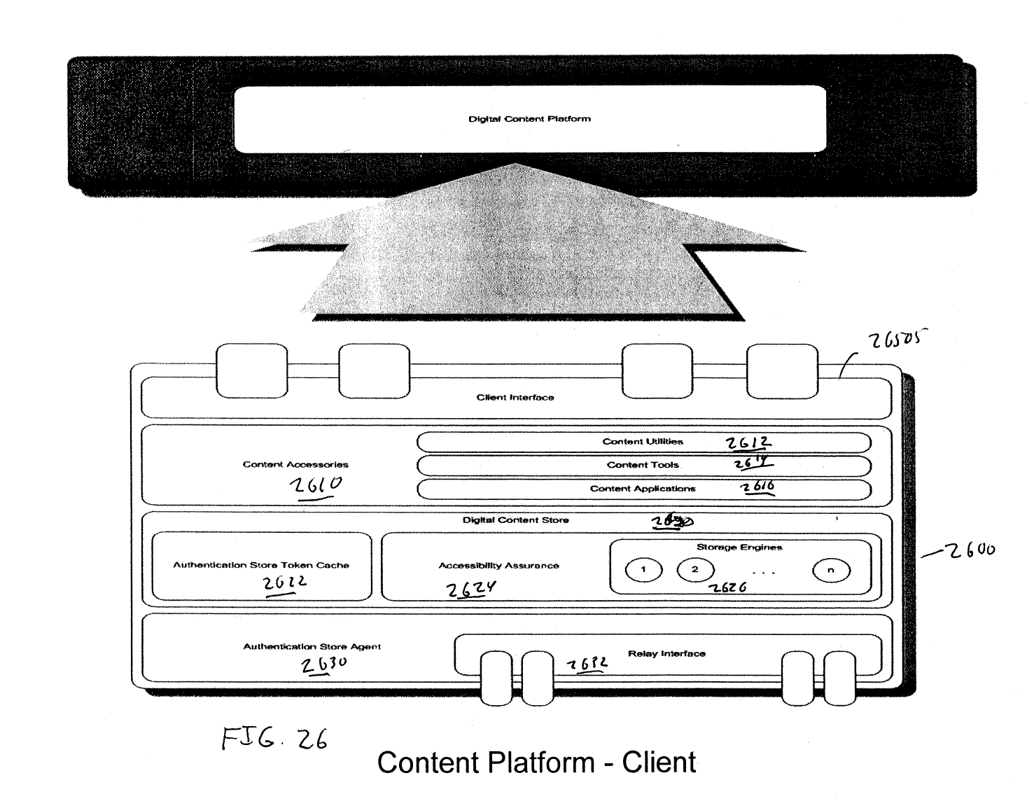

FIG. 25 illustrates an embodiment of a Universal Presence Aggregator (UPA) 2500. As previously described, in computing terms, ‘presence’ is defined as a status indicator that conveys the ability and willingness of a potential communication partner—a computer user, for example—to communicate. In one embodiment the UPA is implemented as a server-based software product that gathers all the presence information from myriad public and private presence systems, such as instant messaging services, directory naming services on corporate- or business-networks, land-based phones, cell phones, and more. (These systems are conceptually addressed as ‘multiple points of presence,’ or MPOP.) The UPA takes the MPOP and creates a ‘single point of presence’ or SPOP. Access to the SPOP is provided to the client side via a Universal Presence Client (UPC) 2550, and an API for third-party applications 2570. That is, the UPA combines aggregated MPOPs into an SPOP, and makes the SPOP accessible through a server-based application programming interface, such that client- and server-based software can effectively use presence information to launch and coordinate applications.

The server-side Presence Coordinator (SPC) 2505 is implemented in one embodiment as a server-based software program that gathers multiple points of presence into a single, authenticated, presence unit. A ‘point of presence’ is defined as any software- or hardware-and-software based entity that can authenticate a user against a presence service.

A node monitor 2510 establishes sessions with multiple points of presence using multiple software interfaces 2515, with an exemplary set of interfaces including an IM Client Emulator interface, Directory Services Interface, Telecom Interface, and iCalendar interface. The Instant Message Client Emulator, is implemented using software that appears to the external point-of-presence as Instant Messenger client software. The Instant Message Client Emulator uses a user's account and password information to authenticate itself against an external IM service, and as far as that service is concerned, the Instant Message Client Emulator is a person logged in via his or her IM client. Another exemplary software interface is a Directory Services Interface, which is software that provides a programmatic interface to Local Area Network or Wide Area Network naming services. (‘Naming services’ in this context are network-based databases of user information, in which each user is unique and the information is used to authenticate the user on the network. Some examples of modern naming services are Microsoft's ActiveDirectory, the IETF LDAP standard, and Sun's Java System Directory Server.) A telecom interface is a software API that provides a programmatic interaction with telecommunication systems. In one embodiment it is further divided into PTSN and Cell phone interfaces. The PTSN Interface is a ‘public switched telephone network’ interface where PSTN is the network of the world's public circuit-switched telephone networks—in other words, traditional land-line phones. The PTSN interface provides programmatic connection between a PTSN device and the SPC. Because PTSN devices (usually the traditional telephone) are offline much of the time, the connection is not session-based but trigger-based. Either the SPC or the user initiates a connection, thus triggering an interaction. A cell network interface provides programmatic connection between a cellular telephone network and the SPC. Because cell phones are offline much of the time, the connection is not session-based but trigger-based. Either the SPC or the user initiates a connection, thus triggering an interaction. The iCalendar Interface (iCal interface) is an interface to iCal, where iCal is the IETF standard for scheduling and calendar information exchange described in IETF RFC 2445. The SPC's iCalendar interface provide programmatic interaction with any iCalendar client. Again, like the phones, iCalendar does not create and maintain a persistent session, and therefore its interaction with the SPC is trigger-based.

An Instant Messaging Interface 2520 is included for the SPC to communicate with the Universal Presence Client 2550. The multiple points of presence are collected into a SPOP, and that single point of presence is communicated with the Universal Presence Client 2550 via the Instant Messaging Interface 2520. This interface is preferably session based and also preferably has a rich API to allow the user, through the Universal Presence Client, to operate the Universal Presence Aggregator.

The SPC Application Programming Interface 2507 is an interface layer that surfaces the full functionality of the SPC to both the UPC and third-party applications, in the form of remote procedure and remote function calls. The SPC API is differentiated from the Instant Messaging Interface to the SPC by the fact that the former is meant to make all product features available, while the latter interface provides instant messaging functionality and application launching

A media routing layer 2525 is preferably provided. In one embodiment, one of the core features of the Universal Presence Aggregator is to supply media to authenticated clients. This does not just mean sending media (archived audio or video, or real-time streaming audio or video) to clients, but also connotes the arbitration of multiple client sessions so as to keep media playback synchronous between clients. The net effect of this is that through the SPC, users can participate in an audio, video, or web conference that is based on presence information.

The Universal Presence Client (UPC) 2550 is preferably implemented as a software component that supplies instant messaging features, along with application launching and coordination on the client side. The UPC 2550 is divided into three sections: an Instant Messaging Client, an Application Launcher, and Media Playback. The Instant Messaging client provides full instant messaging functionality, including authentication, presence status, file transfers, and VoIP connections. The Application Launcher initiates collaborative work on a user's computer, based on upon presence information supplied by the SPC. So for example, a user would note that three co-workers are present on the network, and initiate a web conference with them. Once an application is launched, it communicates with the SPC via the SPC API. The UPC contains a media playback component that coordinates and supply single or multiple video streams. It can display these streams itself or supply them to third-party applications. The integration of a capability to support multiple real-time video streams into a Universal Presence Aggregator provides a unique capability to enhance collaboration.

In one embodiment meeting templates are provided to create meetings relevant for a purpose, such as board meetings, interviews, etc. In one embodiment a meeting template is an XML file that describes a set of applications that will be used in that meeting and their configurations, roles that will be played in the meeting and any default users associated with the roles, and any default content that needs to be accessible to participants in the meeting. As an illustrative example, a user creates a meeting for a purpose. The corresponding meeting template is defined, such as an XML file for “create a board meeting on Mar. 3, 2006.” As a result, the XML file is used by the architecture to invite all relevant users, make relevant applications available, and provide minutes of previous board meetings to be shared for review. In one embodiment meeting templates can be created from other meeting templates or meetings.

In one embodiment, users can embed a software button in applications to initiate a meeting via a business process engine. In this embodiment, each application has a button with the relevant users to initiate a meeting, such as authors of content or reviewers of content. Thus, as an illustrative example, an action item from a meeting may be to draft a new document. A button may be embedded in the application as it is drafted. Authors or reviewers of the application may then conveniently initiate a meeting as they peruse the application by pressing the button.

For ordinary in-person meetings only one meeting is possible at any one time. However, in many workplaces users desire to multi-task between different meetings in order to increase their efficiency. Consequently, in one embodiment, a user interface permits a user to participate in different meetings at the same time. This may, for example, be a form of pure time-slicing in which the user interface permits a user to seamlessly jump from meeting-to-meeting. That is, a user may want to actively make a jump from participating in a portion of one meeting to actively participate in a portion of another. However, a user may also want to keep a representation of a lower-priority meeting playing in the background using a different media type than a higher priority meeting in order to retain context for switching between meetings. For example, the user interface may provide contextual information on other meetings (e.g., status information, textual cues, audio cues, visual cues, or other information indicative of the progress of another meetings) to assist a user to jump between meetings.

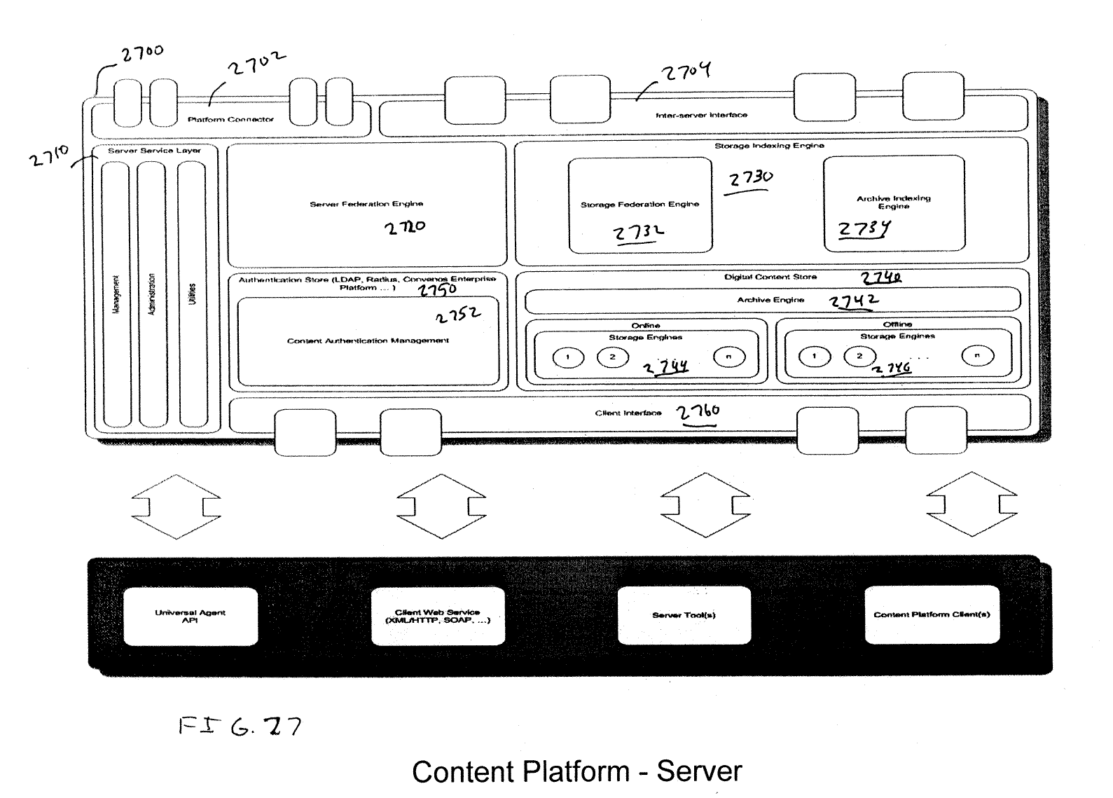

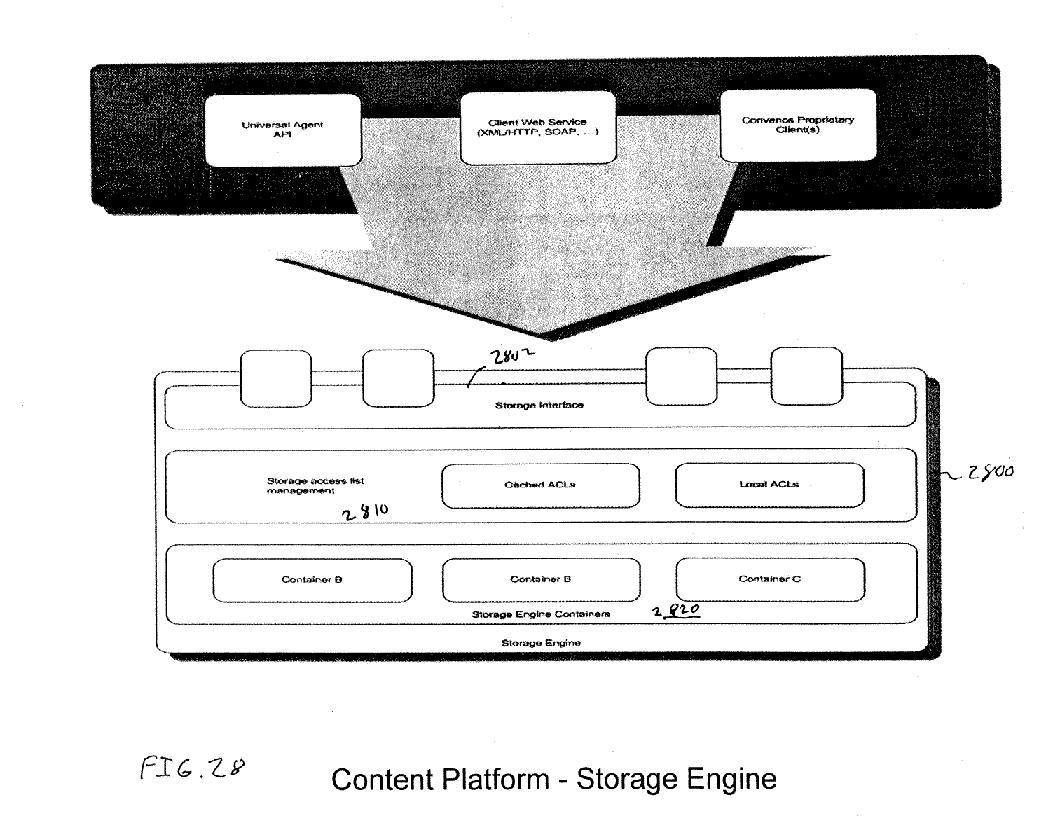

In one embodiment, an Enterprise system embodiment supports the archiving and sharing of digital content (including various types of media) via a Digital Content Platform (DCP). Referring to FIGS. 26, 27, and 28 in one embodiment, the Digital Content Platform (DCP) includes a Digital Content Platform Client 2600 (FIG. 26), Digital Content Platform Server 2700, and Digital Content Storage Engine 2800 (FIG. 28). Firstly, a Digital Content Client 2600 submits authentication credentials as well as receiving authorization to participate in the platform is interfaced to the Digital Content Server 2700. The storage engine 2800 is accessible by the Digital Content Server 2700. The DCP also preferably includes a set of additional tools that allow for subscribers to deposit Digital Content in the Digital Content Platform via means of a Universal API and/or custom utilities. These tools are intended for media providers to manipulate files, storage containers or other assets within the Digital Content Platform without using a Digital Content Client. These tools are collectively referred to as Digital Content Platform Tools.

In one embodiment, the digital content client 2600 includes a client interface 2605, content accessories 2610, including content utilities 2612, content tools 2614, and content applications 2616, a digital content store 2620 including an authentication store token cache 2622, accessibility assurance 2624 (further including storage engines 2626), authentication store agent, and relay interface 2632.

In one embodiment, the digital content server 2700 includes a platform connector 2702, inter-server interface 2704, server service layer 2710, server federation engine 2720, storage indexing engine 2730 including a storage federation engine 2732 and archive indexing engine 2734, digital content store 2740 including an archive engine 2742, and online and offline storage engine s 2744 and 2746, authentication store 2750 including content authentication management 2752, and a client interface 2760. In one embodiment an individual storage engine 2800 includes a storage interface 2802, storage access list management 2810 with cached and local ACLs, and storage engine containers 2820.

Individual client(s) 2600 may have a variety of roles in the Digital Content Platform. Their core functionality with respect to the DCP, however, is to keep a local inventory of Digital Content deliverables that are associated with the currently authorized credentials being used to access the Convenos Enterprise System. Their extended functionality beyond acting as an endpoint for such Digital Content is to become a relay node for other Digital Content Clients. Digital Content Clients may also be used to validate content, which can be in and by itself set to expire. Digital Content Clients may also coordinate with the System to check if an endpoint requires a component to access Digital Content that is being downloaded; this is dubbed Accessibility Assurance.

Expiration of Digital Content is a function of the system being made aware that Digital Content is no longer intended for consumption by groups of users or individual users. Inability to connect to the system within a certain time frame regarding Digital Content that has been marked with expiration timers will automatically invalidate the Digital Content for consumption on the endpoint. An endpoint that contains invalidated Digital Content does not necessarily purge invalidated Digital Content immediately. End-users have a choice to manage the capacity of the Digital Content that is stored on an end-point, and the Digital Content Client makes programmatic decisions about when to reclaim space for other deliverables. The system ensures circumvention of the time-based expiration by means of program-internal time tracking mechanisms that are among other things dependent upon the actual run-time of the Digital Content Client on the system and not the system's clock. If a local time is needed, clients will request this time from a central authority unless the type of Digital Content is not sensitive enough to require time from a centralized location.

Accessibility Assurance governs the ability of the Digital Content Client to provide access to the downloaded Digital Content within reason. This does not imply a set of accessory applications for native file formats necessarily, but does refer to utilities needed to open non-standard, proprietary containers or file types. An example of such a utility would be one enabling access to a proprietary, versioned, storage container, file type or archive that by itself has non-traditional utility applications, but is needed in order to render service to an application outside of the Digital Content Platform. Utility functions within the realm of Accessibility Assurance cannot be called from outside of the Digital Content Client.

In an extended mode, a Digital Content Client may become a relay for deliverables that are to be consumed further downstream. A Digital Content Client may at most relay Digital Content for subscriber groups permitted by the Enterprise System and those subscribers that the Digital Content client is made aware of either directly via the Enterprise System or indirectly via peer-to-peer presence management. Digital Content provided by the Digital Content Platform can be defined such that its ability to be relayed for certain requesting endpoints needs to be cleared with the Enterprise System. This ensures that Digital Content cannot arbitrarily and without consent trickle down to remote relays.

Digital Content Servers can be single, federated, clustered, redundant, or tiered actors in the Digital Content Platform that govern Digital Content Clients' ability to access or otherwise consume files, file containers or other assets stored within the Digital Content Platform. A Digital Content Server is required whenever a Digital Content Client intends to share locally prepared assets with another actor or entity within the Digital Content Platform. Digital Content Servers can be single instances, but they require certain services from the Enterprise System in order to provide those file distribution services. In the absence of that system and the authorization, access-control, account maintenance and extended inter-entity and intra-entity communication services provided by the Enterprise System (hereafter called directory & system services), the Digital Content Platform may alternatively utilize additional actors and entities to provide these directory & system services.

The Digital Content Server includes provisions for accessing files and assets deposited within the Digital Content Platform. At least one Digital Content Server is needed in order for Digital Content Clients to retrieve, deposit or otherwise access assets that are intended to be shared with non-local Storage Clients. Digital Content Platform Tools may be utilized to interface with Digital Content Servers for the means of depositing and/or preparing assets for consumption within the Digital Content Platform.

The definition of Digital Content Platform Tools as it pertains to a Digital Content Server includes any graphical or command-line, or other appropriate tools needed to administer, manage or maintain or otherwise interact with a Digital Content Server outside of the realm of general user interaction.

Administration of a Digital Content Server concerns any and all aspects needed for initializing a Digital Content Server and enabling it to work with the Digital Content Platform. Managing a Digital Content Server concerns any and all aspects needed to ensure mechanical and operational fitness of a Digital Content Server during operation and/or failed operation. Maintaining Digital Content Servers governs routine maintenance tasks that will ensure continued operation of a Digital Content Server within the Digital Content Platform. This includes tools needed to federate and/or otherwise partition portions of Digital Content stored within the Digital Content Platform. Partitioning Digital Content can involve optimizing locality of assets with respect to target audiences within the Digital Content Platform as well as making Digital Content more available. Digital assets do not deteriorate when they are consumed, but the resources gating their consumption are adversely affected for every actor or entity that is involved in the process of asset consumption. As such, the Digital Content Server contains indexing services and peer/node-awareness such that federated, tiered, clustered or redundant Digital Content Servers within the platform are aware of storage engines that are local to them as well. A Digital Content Platform can have one or more partitions. A partition can also be defined by user groups or users of actors and entities participating within the Digital Content Platform.

At least one or more indexing service is required in order to provide asset awareness and asset locality. Indexing service can be a simplified mode by which a Digital Content Server only caters to incoming requests and provides responses as to whether or not the requested resource(s) are valid. In an enhanced mode of the service, the indexing service itself can provide a cached status about the files, file containers or other assets contained within a storage engine. The indexing service itself can be federated, tiered, clustered or otherwise made redundant such that Digital Content Servers are not impacted serving content.

Digital Content Servers in a federated, clustered, tiered or redundant mode can make decisions about which Digital Content Server is to serve the actual file request. Metrics such as and not limited to locality, system usage, resource scarcity, time of day or other user segmentation can be utilized by a Digital Content Server to outsource the file request to another Digital Content Server. An inter-server communication protocol is utilized between target and source Digital Content Server is utilized in order to facilitate this request. Only Digital Content Servers may participate in this inter-server communication. It cannot be relayed by other actors or entities of the Digital Content Platform, but this traffic can be encapsulated and be otherwise consumed by actors and entities of the Enterprise System.

Federation pertains to geo-graphically distributing Digital Content within a Digital Content Platform across multiple Digital Content Servers and includes all or a subset of the Digital Content in the Digital Content Platform. Federation can occur by the aforementioned metrics. Clustering refers to duplicating or otherwise distributing Digital Content within a partition of the Digital Content Platform. Clusters collectively contain all assets defined within a partition, and may contain one or more or no copies of said assets. Tiered Digital Content Servers refer to an n-ary tree structure whereby all Digital Content Servers are connected, and Digital Content gets distributed from root node to leaf nodes. Digital Content must not be inserted at the root node and can be inserted or manipulated at any. Nodes can be marked such that they do not participate in Digital Content received from. The Digital Content Platform is aware of space constraints when inserting Digital Content at higher nodes within the n-ary tree, and insertion will be avoided when newly added Digital Content will surpass the capacity of any Digital Content Server participating in the tiered replication further downstream. The Indexing service provides information about locality of Digital Content within the Digital Content Platform. Redundant Digital Content Servers contain exact replicas of the partitions contained on the member Digital Content Servers making up a redundant pair. Facilities and mechanisms within the Digital Content Platform and Indexing service ensure availability of the service in the event of individual entity losses or other factors affecting service uptime.

Digital Content Servers are also crucial in the enforcing of resource consumption aspects as they pertain to the Digital Content Platform. Through coordination with the Enterprise System, a Digital Content Server can determine if a user group or individual users have usage restrictions. Delivery of assets can be stopped by a Digital Content Server should those restrictions have been met. Digital Content Servers can also provide feedback to Digital Content Clients alerting human operators that they can take actions to adjust these constraints. A constraint includes but is not limited to the bandwidth that has previously been consumed by a user group, individual user, actor or other entity within the Digital Content Platform within a certain time frame.

Storage engines can refer to a wide variety of physical or in-memory, online and offline file storage. Storage engines may also be operated by third parties so long as sufficient utilities exist to make the Digital Content Platform aware of the storage engine in question. In its barest definition, the storage engine serves to provide access to containers of files and assets, which can be consumed via the Digital Content Platform.

A storage engine provides meta-information about the original file types contained within containers, or individual file types that were deposited within the Digital Content Platform. It guarantees to components abstraction for underlying technologies such that components interfacing with a storage engine can always deal with a known set of interfaces, syntax, grammar or general means of retrieving, depositing, manipulating or otherwise accessing containers or other assets.

A storage engine also provides access control for the entities within the Enterprise System that intend to access assets contained within a storage engine, and ensures that only authorized participants are allowed to perform operations on a storage engine. Non-membership in the Enterprise System prevents access to a storage engine. Non-entitlement as defined by entities and/or actors of the Enterprise System prevents said entities and or actors to perform operations on a storage engine that they are interfacing with.

Storage engines are not limited to client-prepared or local content, even though it is feasible for a Digital Content Client to be interacting with a storage engine that is local to the Digital Content Client, but also foresees storage engines that are hosted within the Digital Content Platform and/or are distributed via entities or actors participating in the Digital Content Platform. 3rd party online or offline file storage can only be integrated via Storage Engines as Digital Content Platform storage engines ensure actors access to underlying files and assets as per access control provisions defined via the Digital Content Platform.

Digital Content Platform Tools enable 3rd party applications to participate in the Digital Content Platform by means of an API and/or allow participation in the Digital Content Platform by means of a proprietary tool other than the Digital Content Server or Client and its tools and accessories. Entities or actors may thus insert, modify or otherwise manipulate Digital Content or assets stored within the Digital Content Platform.

Archival of assets within the Digital Content Platform foresees transitioning assets from an online Storage Engine to an offline Storage Engine. The Digital Content Platform includes mechanisms for performing this transition seamlessly without interrupting to actors or entities within the Digital Content Platform. Mechanisms for moving Digital Content offline include but are not limited to metrics such as how frequently the Digital Content was accessed, whether assets were marked for archival by a Digital Content Platform Tool or Digital Content Server mechanism, or if Digital Content Clients participating in the subscription of the Digital Content have not been seen on the Digital Content Platform within a certain time interval. Archival frees resources from online Storage Engines across any and all Digital Content Servers participating in the subscription of the assets that are to be archived. Archived Digital Content can still be requested from Digital Content Clients later on, but Digital Content Platform Tools or long-time non-participation of Digital Content Clients likely marked these assets for archival in the first place.

The Digital Content Platform through its interaction with the Enterprise System can determine whether a user group or individual users that have deleted assets also subscribe to archival service. Deletion of assets in these instances then transitions online assets to an offline Storage Engine that frees subscribers' Digital Content Space up for other assets, while maintaining a record of their archived and non-used files.

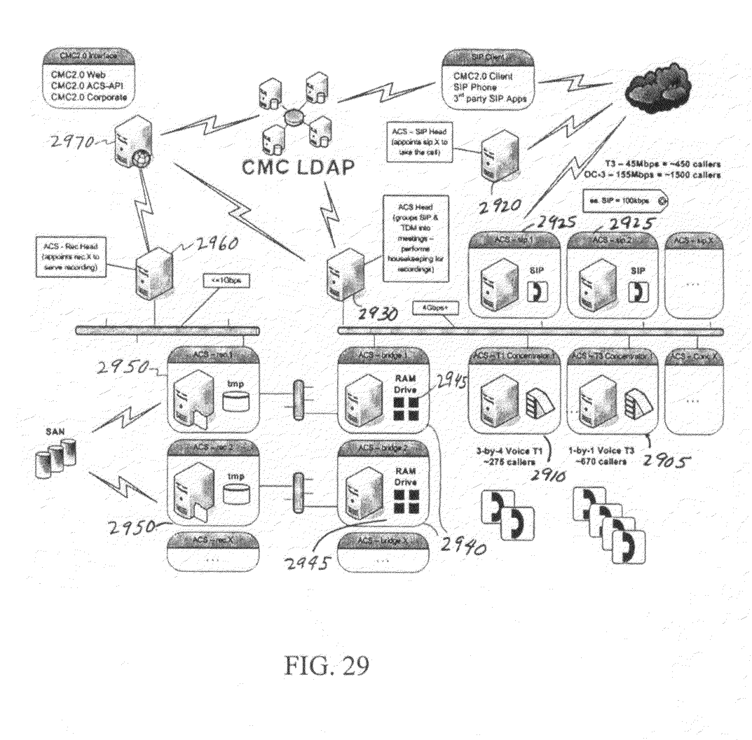

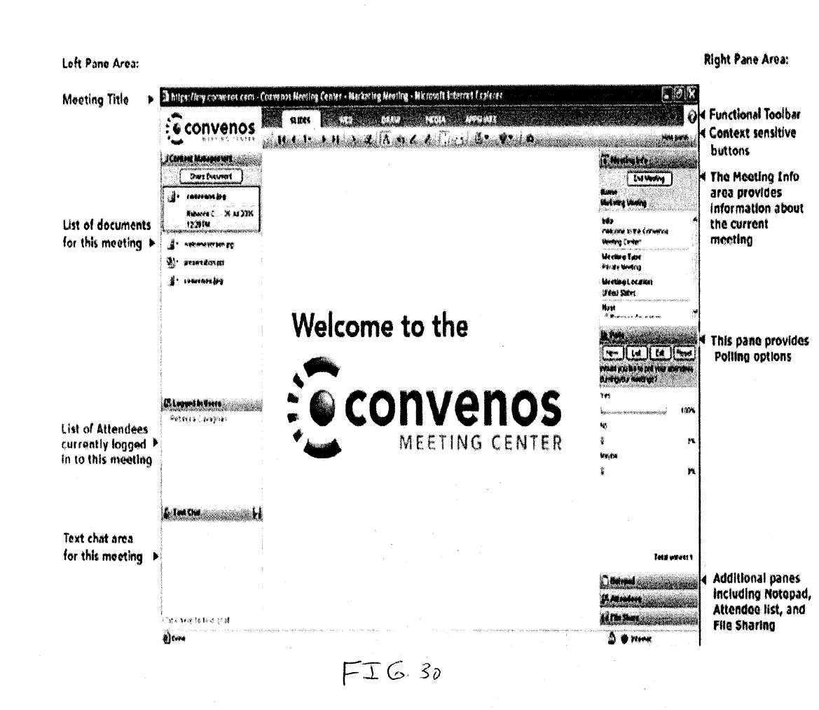

Referring to FIG. 29, in one embodiment an audio conference server (ACS) is provided to support different audio options, such as using a phone conferencing bridge or VoIP. Components embodiment are also referenced by CMC2.0, which denotes a second generation CMC with enhanced audio options. Digital signal (DS) protocols may be used to convert incoming phone calls to a digital format which may then be further converted to VoIP.

The ACS system includes concentrators, such as T1 and T3 concentrators 2905 and 2910. Each DSx/Tx Concentrator accepts incoming calls via the PSTN (Public Switched Telephone Network) and a variety of DID (Direct Inward Dialing) numbers assigned to a specific Concentrator, which are in turn associated with either a grouped-DS1 or DS3 service line. DSx/Tx concentrators need to be sized such that they can continue to operate at their designated load level (multiple DS1s at 23 calls each or DS3 at ˜672 calls each). Grouped-DS Is can span over several machines, however. There are voice vendors for which there is no limit as to how many of these DS1s can be in one group. In one embodiment the hardware is based on x86 multiprocessor systems for this component of the ACS due to the ready availability of driver support for the cards that will accept these calls. Commercially available cards for a Dual-Xeon 3.2 GHz system can presently accept 12 DS1 lines for a maximum of 12*23=276 calls per machine. Xeon machines with better than dual-SMP configurations are available on the market. A DS3 card is in beta development slated for release in Summer 2006.

Once a call comes in via one of the DSx methods, it is converted into digital format using either IAX or a session initiation protocol (SIP). The Codec may include, for example g.711 uLaw or H.323. From this point on, the PSTN signal is ready to be switched via the ACS network fabric to other ACS components. The machine acting as a DSx concentrator thus needs to perform two major tasks: PSTN call acceptance and PSTN-to-VoIP conversion.

Concentrators 2905 and 2910 also need to be aware of dynamically-created conference rooms, which they will ideally resolve via the peer-to-peer Dundi protocol. Inter-component communication should happen via the open-source IAX protocol.

The ACS system includes ACS SIP heads 2920 and ACS sip Concentrators 2925. Unlike the DSx/Tx Concentrator component, the sip Concentrator does not require specialized hardware to accept calls. As such, it is not deemed to be limited to a specific hardware platform, and is only limited by the amount of available Internet bandwidth that it can process. The concentrator/head system is indifferent to the type of architecture being used. Whether it is an SMP-processor Sun Edge or a larger quantity of less powerful machines.

Ideally, the sip Concentrator can accept calls via a variety of codecs such as G.711 and G.729 or any future codecs, which CMC2.0 will support. The downside to not having any specialized hardware that physically limits the amount of calls, is that an additional SIP director (referred to as the “sip Head”) may be required. Each sip Concentrator is connected to the sip Head. The sip Head acts as the universal point of contact for CMC2.0 clients that wish to participate via SIP in a “hosted” conference call. One component of the setup (i.e. client, sip (lead or CMC Back-office) needs to be aware of the number of audio clusters that are deployed in various locations to ensure the best latency to the client. A client connecting from Europe should be able to select an ACS cluster in Europe, if one is available. Ideally, this process will not require any type of user selection and or profile modifications and is done automatically. A client that changes geographic locations should not have to modify a static profile to ensure the best initial latency to the cluster. The sip Head either needs to proxy traffic to each sip Concentrator, or redirect traffic to each sip Concentrator. Redirecting is deemed to allow for a higher traffic load, but may require a special token exchange to be implemented to prevent clients from connecting directly to a sip Concentrator. Proxying will make the Concentrators less transparent to the clients, which is positive, but will require the sip Head(s) to relay the total sum of all Concentrators' traffic loads.

Ultimately, any one machine should be prevented from accepting more SIP traffic than it can handle and any one machine should be forced to use only a controlled portion of the Internet bandwidth that is available to the cluster as a whole. The sip Head needs to be able to gauge the amount of SIP channels in use on each sip Concentrator at any time along with the codec's aggregated bandwidth utilization. This information is needed for sip Head's redirection efforts to ensure processing loads and bandwidth loads do not exceed predefined limits. An arbitrary system index may have to be developed which gets passed from “sip Concentrators” to “sip Head” and always contains the most current representation of available CPU/RAM and network bandwidth used. Sip Head can then make the best redirection decision based on a number of configurable algorithms TBD.

The ACS system includes ACS bridges 2940. This is the center piece of the audio conference and actually combines PSTN and VoIP callers into one conference. Since PSTN calls are converted to VoIP by the DSx/Tx concentrators, there is no need for ACS bridges to be in the same geographical location as the concentrators, but bridges should be close to concentrators to avoid latency issues. Bridges can be pre-configured with a number of conference rooms (i.e. Bridge.1=0001-4999, Bridge.2=5000-9999), or these conference rooms can be provisioned automatically by the ACS head. The peer-to-peer component protocol would ensure that calls coming in via concentrators always find the bridge they need to reach even if the caller does not know about the location of the bridge. Bridges should be chosen by the ACS head according to geographic proximity to the user that is setting up the conference. A United States CMC2.0 user will setup a hosted conference in an U.S. ACS cluster. The CMC2.0 Back-office thus needs to refer to a hosted conference room in the U.S. ACS cluster and not the European ACS cluster, such that a caller can dial a U.S. phone number and/or reach a U.S. “sip Head”. Recordings and any further information kept about conferences is specific to each geographic ACS cluster. If conference rooms are to be universally available via VPN-connected ACS clusters globally, then this decision will dictate which direction the VoIP streams are taking to the conference room.

The ACS bridges are equipped with RAM drives 2945 allowing for conferences to be recorded without dragging system performance down. These RAM drive recordings are to be stored to disk using a separate network switching fabric (separate from the fabric handling voice communications and inter-component communication). The bridges do not perform any type of audio conversions so as to make them as geared towards handling as many conference participants as possible. There are preferably no proprietary protocols needed for this portion of the conference process.

Recorded conferences can be transferred to a RAID or SAN-capable server via NFS or any other existing network file sharing standard. One option is to use an ACS rec server. For redundancy, a special protocol choosing the destination ACS.rec server. Alternatively, the AFS (Andre-File-System) can be used for a distributed file server network based on Unix such that an ACS bridge writes to a random ACS.rec via a universal naming convention.

FIG. 29 illustrates an embodiment that contemplates a dedicated ACS.rec machine per bridge. In the interest of redundancy, all ACS.rec machines would have to be on the same network fabric as the ACS.bridges. ACS.rec machines 2950 accept conference recordings from ACS.bridges and store them to SAN or internal RAID arrays. This is to ensure that bridges are not impaired during resource-intensive conferencing operations with a disk storage operation. The disk storage procedure will be performed after the completion of the conference. The benefits for having an external storage system with a detachable processing unit accessing it are that one can replace this processing element should the need arise. An internal storage system (internal to the machine controlling it) will be much more difficult to replace on-the-fly.

The ACS.rec-head 2960 performs a very specialized task and thus only needs to talk to ACS.rec machines. It does not need to know about ACS.bridges or ACS.concentrators. It's sole purpose is to select an idle ACS.rec machine to either perform transcoding tasks on already existing recordings and/or choose an ACS.rec to transfer said recordings to a CMC2.0 client requesting it. For transparency and security, these recordings can be transferred to a different cache location within the CMC2.0 Back office, such that clients can never be fully aware of the true source of the recordings. These recordings could be made available to a blogging system within the CMC2.0 Back Office, a client directly or a streaming system within the CMC2.0 Back Office.

One options for the ACS.bridges is a capability to replay existing recordings on-demand and allow a new set of participants to listen to pre-recorded conferences. This scenario is not considered to be likely, but can be a feature-enhancement if need be.

Lastly, backup considerations need to be made. Either a dual-redundant system is called for (i.e. each ACS.rec writes to two physically different storage locations), or backup systems need to be construed that can manage the entirety of the storage array.

An ACS.director 2970 perform pre-conference setup tasks. The ACS.director needs to be aware of the type of bridges available in its cluster, their current processing load, their scheduled processing load (scheduled conference calls with X-amount of users) and also be aware of the number of calls that each respective Concentrator in the cluster can accept. If multi-location conferences are to be conducted, the ACS-director needs to be aware of Concentrator-capacities in those locations as well. This includes both sip.Concentrators and DSx/Tx concentrators.

The CMC2.0 Back Office needs to convey to the ACS-director just how large a conference will be and whether or not it is a multi-location conference. Each ACS.bridge will compute a system index used by ACS.director to determine where to schedule conferences. Conferences could technically live on a 28-processor Sun Edge, but they could also be scheduled on a single processor x86. It is up to ACS-director given as much information as possible from CMC2.0 Back Office to setup a dynamic conference on one of the ACS.bridges. This conference number needs to be relayed back to CMC2.0 Back Office such that CMC2.0 Back Office can distribute it to clients. How this information manifests itself in the client will be up to the CMC2.0 client specifications, but this information should be pushed actively to any CMC2.0 clients that can receive pushed messages.

A static conference room system has the potential to introduce an ad-hoc load that may prove detrimental to dynamically scheduled high-participant conferences. The mechanism chosen to ensure system reliability must also be hardened towards malicious reservations (i.e. users that register several high-participant conferences). If participants had to pay for such reservations and/or CMC2.0 Back Office had appropriate limit switches, then this should not pose a problem. CMC2.0 Back Office should produce reports about the number size of scheduled conferences for dynamic ACS.bridge provisioning. The provisioning is dynamic in that after configuring a single machine and its reporting tool to be used by ACS-director, the newly-added machine can provision conferences immediately, without requiring additional database configurations. Every machine performing audio tasks should be configured using the peer-to-peer Dundi protocol as well. If there are database configurations to be made such that CMC2.0 Back Office can interface appropriately, then ACS-director will make these modifications given the dynamic system index information provided by the system resource reporting agent.

The CMC2.0 Interface for the ACS system revolves around a system that can receive public API (e.g., a vendor-SDK using a software development kit) and private API calls (e.g. ACS.rec-head to Caching system). The ACS needs to be able to accept/process these API calls and, for example, create dynamic meetings and/or transcoding requests, and serve results back to the CMC2.0 Back Office. For the purposes of this document, the Back Office and an “API”-controlled 3rd party back office can be used interchangeably as the idea is to have enterprises be able to use ACS as a portion of their independently designed systems.

In one embodiment, the interface preferably checks with the CMC LDAP system to see whether or not the requesting user has permissions to perform the desired task. The Back Office holds authority over the LDAP configuration settings. A 3rd party back office may be given control over a subset of permissions in the LDAP most likely by company name or domain name.

Provided that ACS can count on the trust-worthiness of the LDAP information, it makes all security permission decisions based on parameters in the CMC LDAP directory. It needs to be seen whether web-interfaces for ACS are to be deployed on their respective ACS.xyz systems (where xyz=sip. DSx/Tx, rec, bridge or director) or whether such interlaces should be integrated into the Back Office and a subset of its API calls be made available to 3rd party back offices. The ACS system would in the latter case purely be configured via API calls and require a listening agent that understands the API protocol and executes tasks based upon the information conveyed in the API transmission. Alternatively, non-unified web interfaces should be located on the respective ACS systems allowing users to for example, only create a teleconference, or only transcode a recording. It is much more preferable to have such application-oriented web interfaces created separately, but based on the common ACS API.

A CMC 2.0 client may be designed such that certain aspects of the hosted audio conferencing option are deemed to be a “premium” service and/or a subscription service. Regular PSTN conferences do not require a subscription. VoIP features and recording features do require a subscription. Unique DIDs for use by certain customers are a special service. By default, the CMC2.0 client may have peer-to-peer conferencing built-in such that SMB (small-to-medium-business) customers can make use of no-cost VoIP. In order to provide portions of the premium services to SMB customers, the client should be designed such that it can accept audio feeds from an ACS cluster and integrate it into the existing peer-to-peer conference.

It is primarily the union of peer-to-peer VoIP and regular PSTN that would be of importance here. Alternatively, there could be different price points for SMB customers such that they can conduct 6 user conferences with mixed VoIP and PSTN. There could also be an implementation in which a device that allows users to convert regular single-line PSTN calls and have those callers participate in a CMC2.0 peer-to-peer VoIP conference. Recording should be handled by the CMC2.0 client in those cases with a utility to have those recordings be managed through a peer-to-peer “Edition” of the CMC2.0 Back Office. Users could thus have a one-stop Audio conferencing repository. However, one alternative would be an enterprise-internal ACS.rec server that would allow users to host/archive and present such recordings to users in a meaningful manner, even if they are not making use of the premium hosted features. This way, they could integrate such recordings with a blogging system, if supported.

Multiple locations would be connected to one another via VPN circuits that would provide bandwidth independent from the one available to connecting SIP clients or the one providing access to recordings. However, one embodiment contemplates having users dialing into a concentrator from a different ACS cluster be routed to where the conference actually takes place. There is nothing in the way of doing this, but there are severe bandwidth and latency issues with this approach. Essentially, there are at least two ways to do the bridging between two locations. As one example, when a European ACS user tries to connect to a U.S. hosted conference via SIP, he/she would be connected to the European ACS based on the selection that ACS.sip-head makes for this user. The call gets processed by a ACS.sip concentrator in the European ACS and has to be routed via an internal VPN to the U.S. ACS cluster, where the conference takes place. Each such user would consume bandwidth on the public European ACS.sip server and consume the same bandwidth on the transatlantic internal VPN connecting European ACS and U.S. ACS.

As another example, European ACS users connect to a conference room that is equivalent to the one U.S. ACS users connect to. The two rooms are bridged using a PBX channel driver that relays DTMF signals (tones emitted by pressing a button on the phone) and streams without re-broadcasting the original content back to the room where the audio originated from. This prevents the introduction of a never-ending echo effect. The DTMF signals are relayed such that a moderator of the conference can still perform advanced features of a conference, such as muting everyone or appointing someone else to be heard. The internal VPN would still be utilized, but a high-user mixed location conference would not see X-amount of streams going back and forth, but rather only one per connected ACS location. This tremendously alleviates bandwidth requirements on the internal VPN.

The added benefit for users in one geographic location would be that they do not have to accept twice the transatlantic transit time to hear their colleagues next-door talk. All users within one ACS cluster can hear each other within reasonable delays. The moderator could also affect parameters of the other conference room via controls on his/her phone whilst being connected to conference room in a different ACS cluster.

In one embodiment web-controls or CMC2.0 client controls for conference rooms are based on an ACS.director for one cluster submitting those changes to the ACS.director in another cluster dynamically to complement the PSTN DTMF feature set. If more than two ACS clusters are combined, then each cluster would have to initiate one of these types of streams to each ACS cluster that is participating in the conference.

However, there are practical issues to address in achieving a pre-defined conference on one cluster that all other clusters can participate in. A dynamically configured conference room could be used to initiate streams between all other participating ACS clusters. Since all servers are participating via Dundi in a dynamic peer-to-peer directory, the servers would also have to have a different internal representation for the multi-location conferences being created. Moreover, ACS.concentrators must be configured such that no incoming caller can refer to a conference in a different cluster. Otherwise, there is the possibility of saturating the VPN link between the ACS clusters and or circumventing the point of having this channel driver for the PBX created in the first place.

Embodiments of the present invention may be applied to manage meetings associated with a project throughout an entire meeting lifecycle. As previously described, in one embodiment, virtual workspaces may be created for meetings. The virtual workspace associated with the meeting may, for example, persistently store documents associated with the meeting, polls, text messages, media files, slide presentations, or other content presented at the meeting. Thus, a virtual workspace may be retained until deleted by a host and made available to either all invitees or to a selected subset. The virtual workspace provides persistent access to meeting details and content to assist users to accomplish meeting objectives and also as a reminder of previous meetings. As previously described, in one embodiment meetings be created that are instant meetings (set up on the fly), scheduled meetings, ongoing meetings, or recurring meetings. In one embodiment a user interface (a “My Meetings” page) provides options for selecting the meeting type, inviting attendees, and granting privileges. For example, for open meetings, different privileges may be granted to Speakers, Participants, and Guest Users to load and/or access materials and applications. Private meetings may be selected in which access is more strictly controlled. The My Meetings page, for example, may include a password protected browser view of meetings a user has created and/or has been invited to. In one embodiment a “Meeting Details” page stores additional meeting details, such as specific details the host defines when creating the meeting (e.g., to define a project title and other descriptive information), attendee information (number of visits, last visit, and role), access to the virtual workspace, including any persistently stored files, and an archival view of notepad entries and polls. In one embodiment, a host can send a transcript via a link to the Meeting Details page.

Also, as previously described, in one embodiment a user can select different audio options for a meeting, such as VoIP (e.g., Skype) or a dial-in conference call bridge. VoIP is free to use when calling from one PC to another. Some hosts may prefer to use conventional dial-in phone conferencing for particular situation. Additionally, conventional bridging is currently capable of supporting a larger number of meeting attendees than main VoIP services. In one embodiment, a user interface provides options to select different audio options.

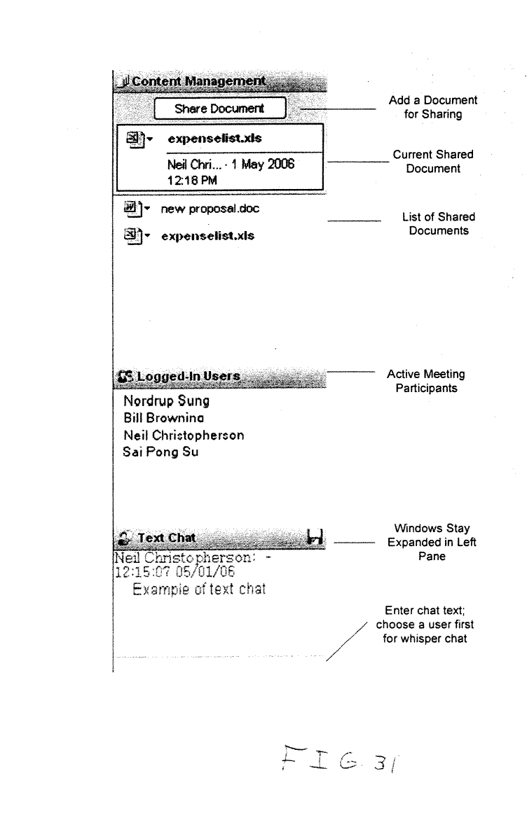

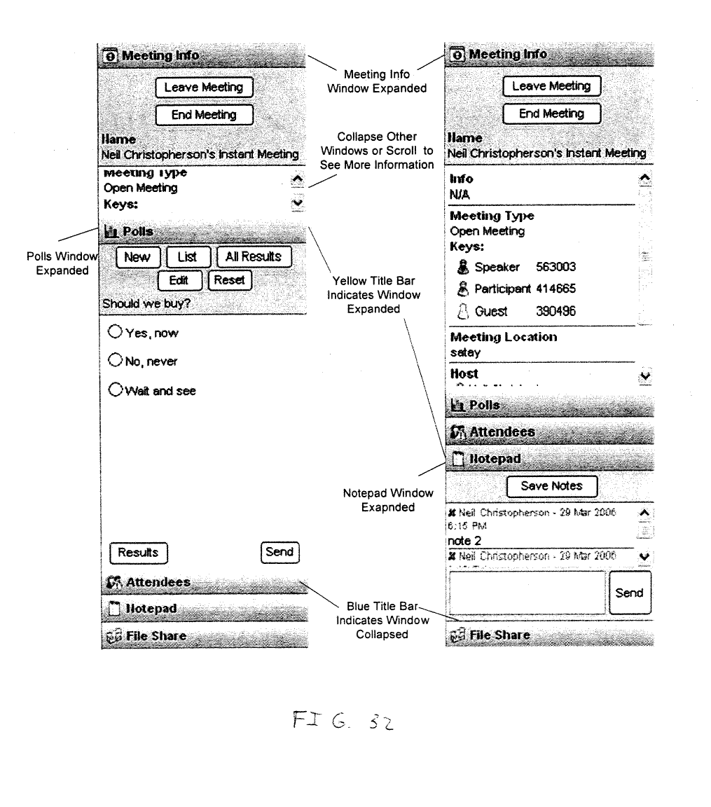

FIG. 30 is a screenshot of an exemplary user interface of a meeting center (in this example, a meeting center of Convenos, LLC, the assignee of the present invention). Left and right panes provide spaces for a list of documents used in a meeting, a list of attendees logged in to the meeting, a text chat area, a meeting title, a space for meeting information about the current meeting, polling options, and panes for a notepad, attendee list, and file sharing. Tabs support the sharing of slides, co-browsing the web, a whiteboard for sharing drawings, media sharing, and application sharing in a center window region. FIG. 31 illustrates in more a portion of the left-hand pane of the user interface. An exemplary list of shared documents is illustrated. A list of meeting participants is displayed. The text chat area shows an example of text chat. FIG. 32 illustrates in more detail examples of right-hand panes of the user interface.

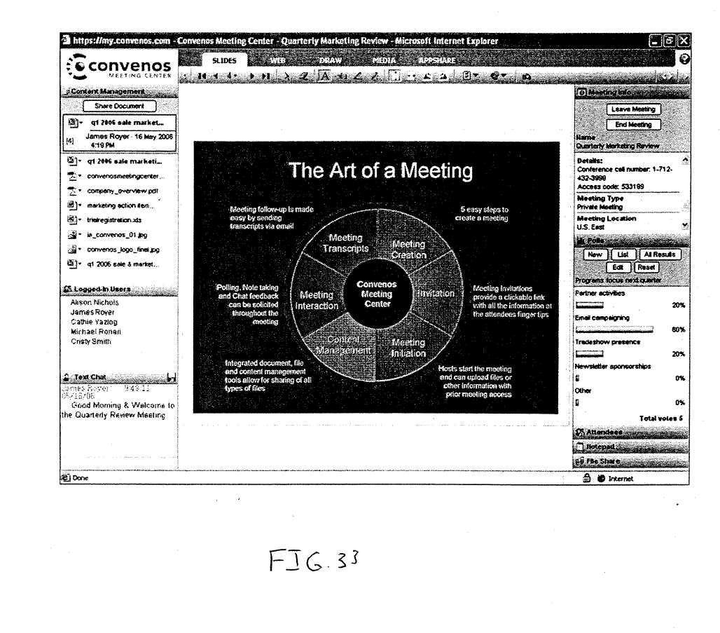

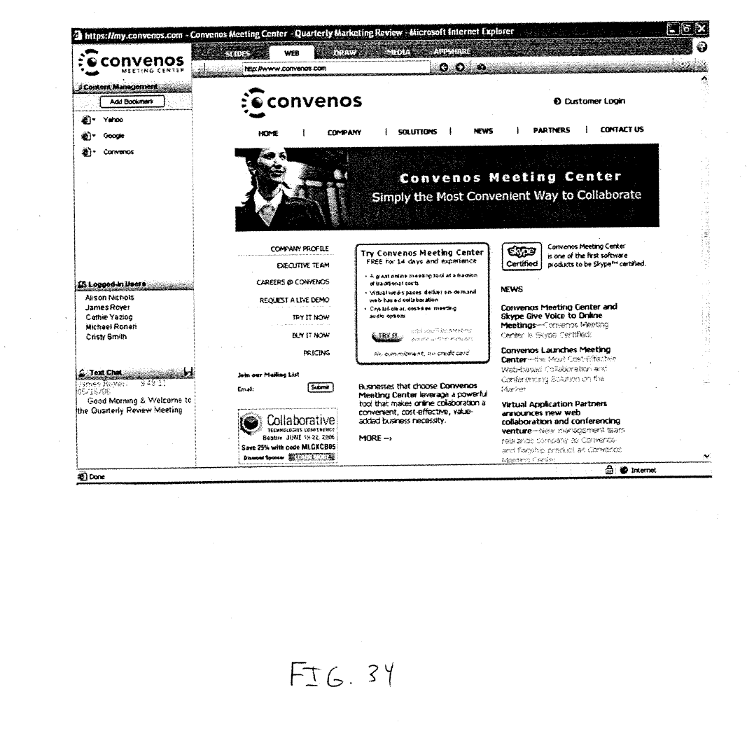

FIG. 33 illustrates an example of a quarterly meeting review with an introductory slide being presented to explain the meeting center. As can be seen in FIG. 33, one aspect of the user interface is that it efficiently displays different types of information. In this example, the shared document (left hand tab) is a fourth quarter sales document. A list of participants is displayed to help participants understand whom is taking part in the meeting. Text chat is displayed. The right hand pane display meeting information, such as the name of the meeting, and details such as a call in number. Polling information is also displayed.

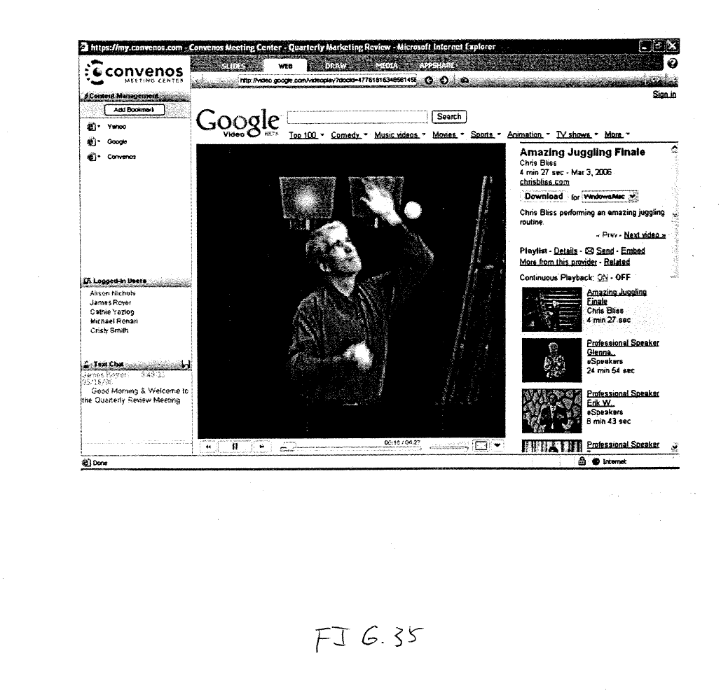

FIG. 34 illustrates a screen shot for the same meeting in which the web lab is used to initiate co-browsing of the web via the previously described techniques. Participants are being guided through a website (in this example convenos.com) in a co-browsing mode. This provides all of the users the capability to see the same webpages automatically.

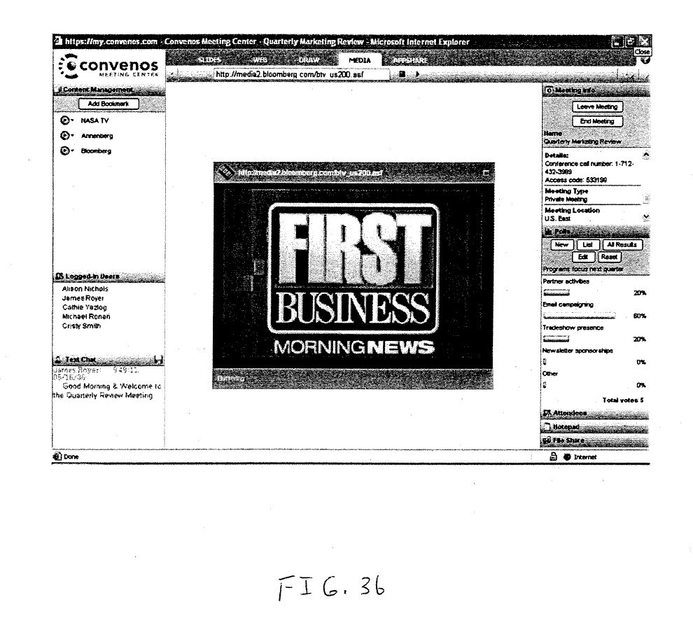

FIGS. 35 and 36 illustrates the sharing of full video files (or other rich media fields) in real time to all participants of the previously described example of a quarterly meeting. FIG. 35 illustrates the video file accessed from the web and FIG. 36 illustrates an example of the video file being accessed from media content.

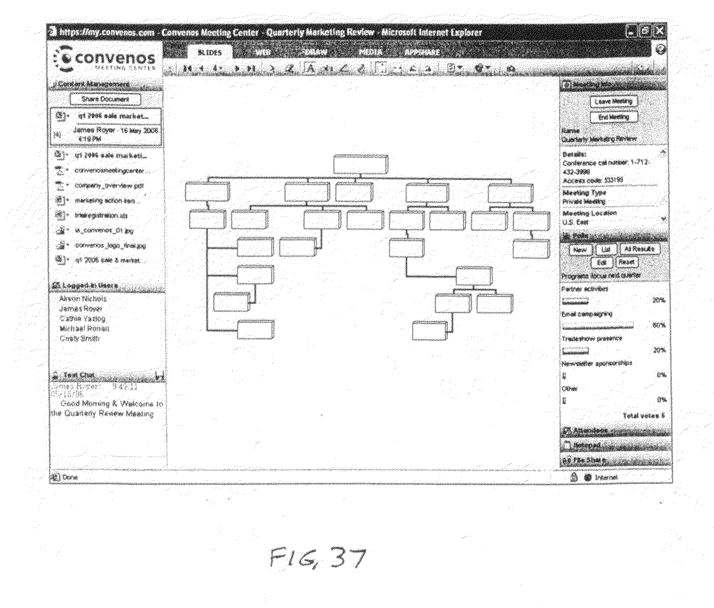

FIG. 37 illustrates how complex documents can be shared using the slide feature. In this example, the slide show may, for example, be based on a slide application such as Microsoft's Powerpoint application.

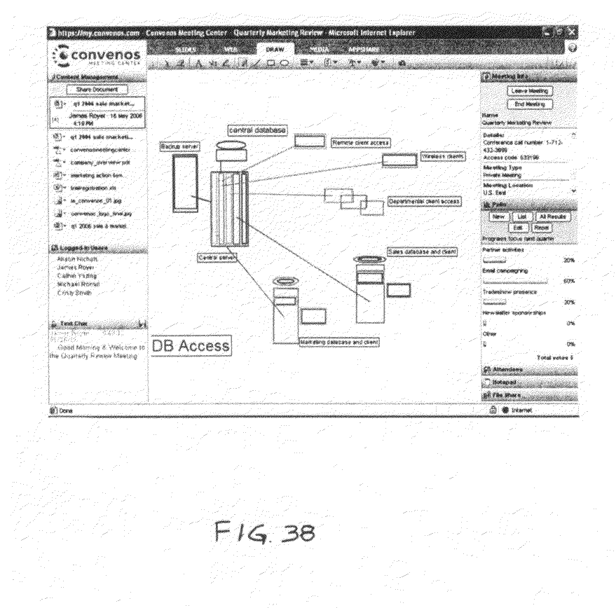

FIG. 38 illustrates how drawings can be generated and shared at the quarterly meeting. In this example, a drawing menu includes features for user's to generate or edit drawings. As a result, the user's have a “whiteboard” in which they can generate, share, and edit drawings during a conference.

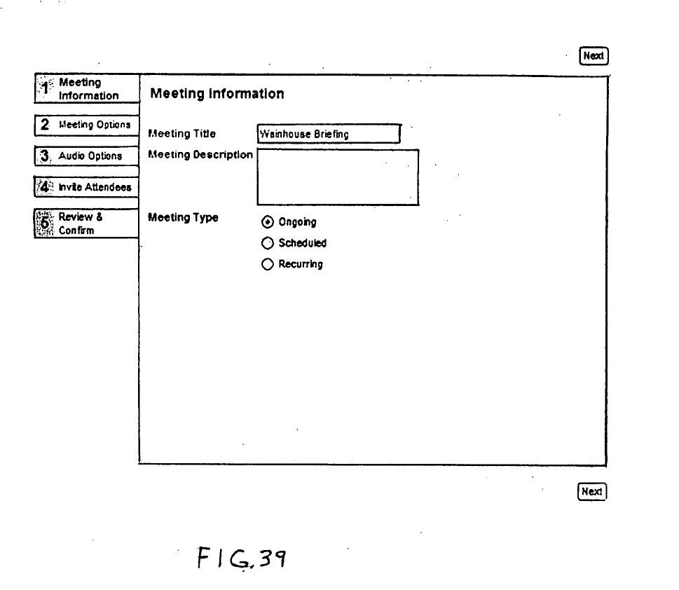

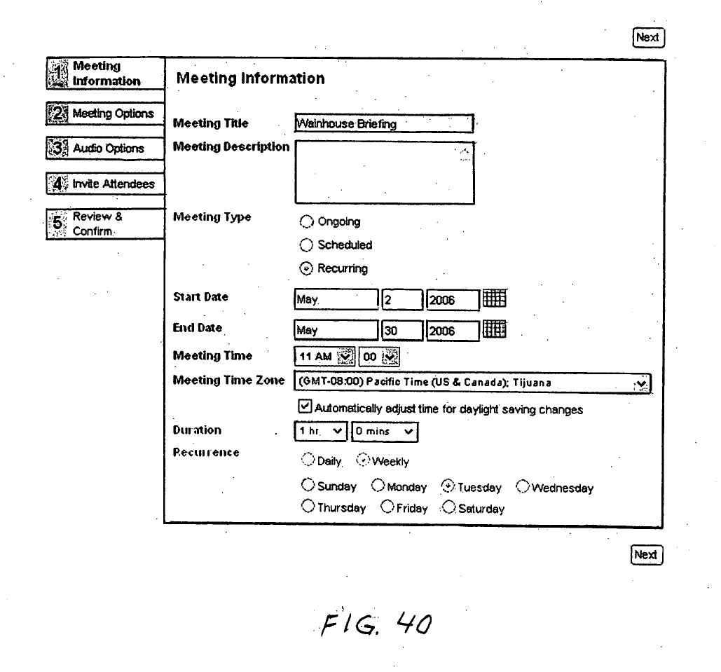

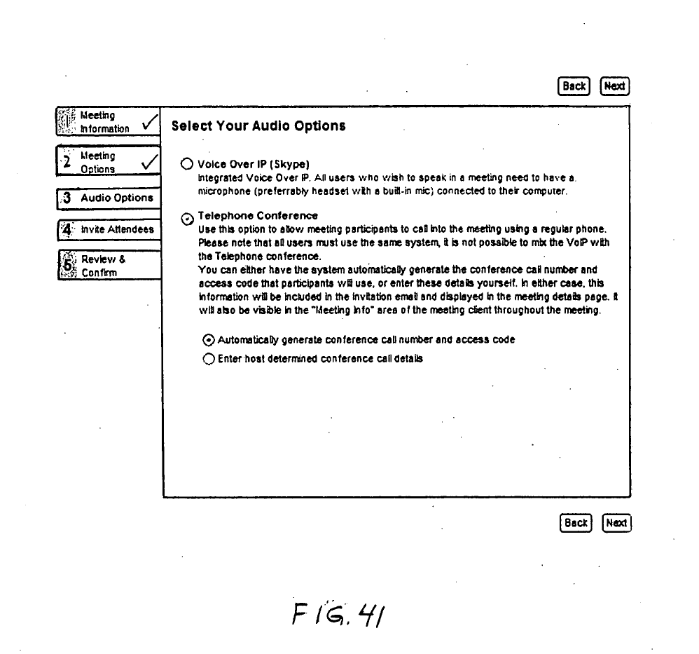

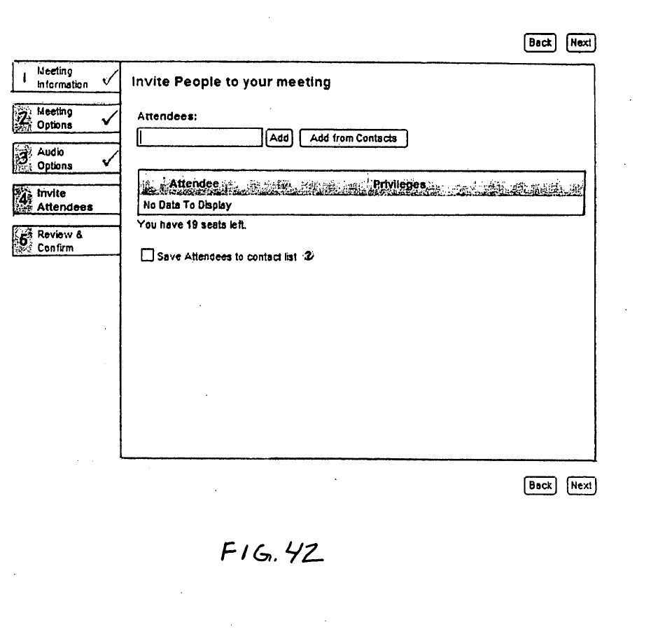

As previously described, in one embodiment there are four different types of meetings; ongoing, scheduled, recurring, and instant. FIG. 39 illustrates a user interface to set up meetings for ongoing, scheduled, and recurring meetings. In this embodiment, a five step process is used having user interfaces for providing meeting information (e.g., meeting title, meeting description, and meeting type), select audio options (e.g., VoIP or conventional phone options), invite attendees (e.g., select attendees, who will be sent an email notification of the meeting), and a review/confirmation process. Note that in one embodiment an additional calendaring feature is provided to schedule meetings, as illustrated in FIG. 40. FIG. 41 illustrates a user interface to select audio options for the meeting. FIG. 42 illustrates a user interface to invite people to an ongoing, scheduled, or recurring meeting.

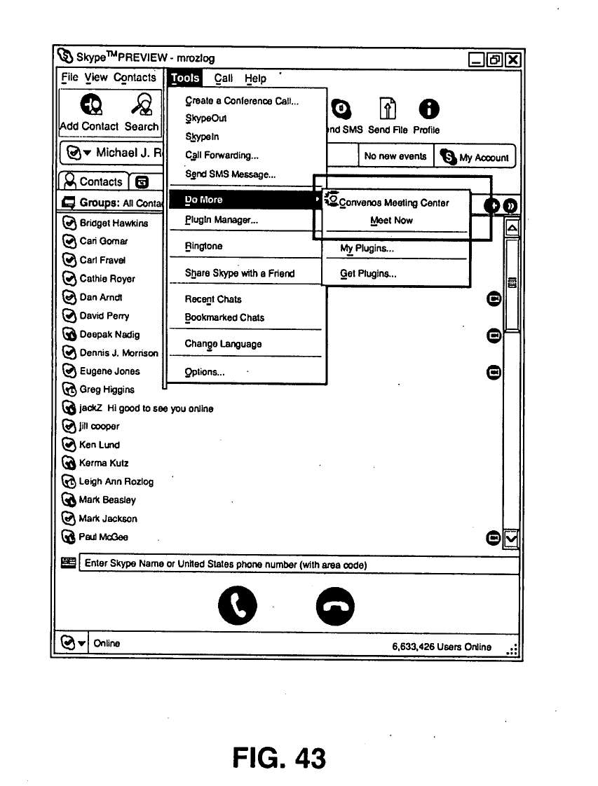

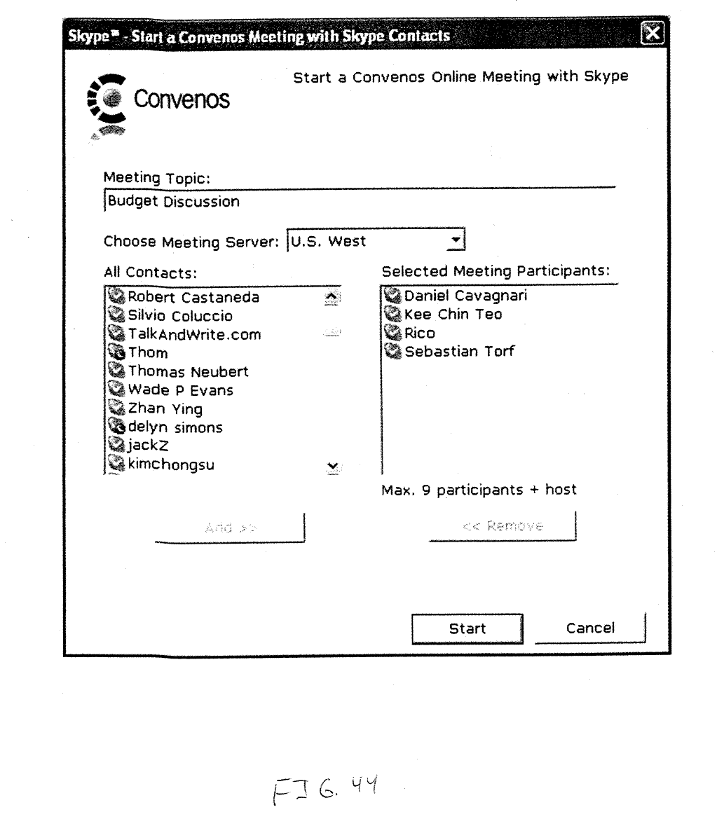

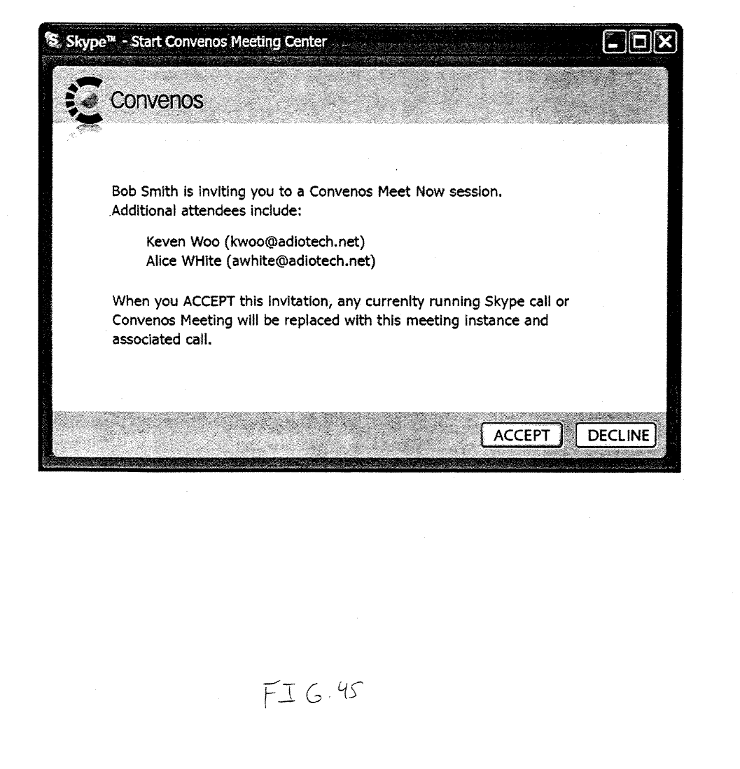

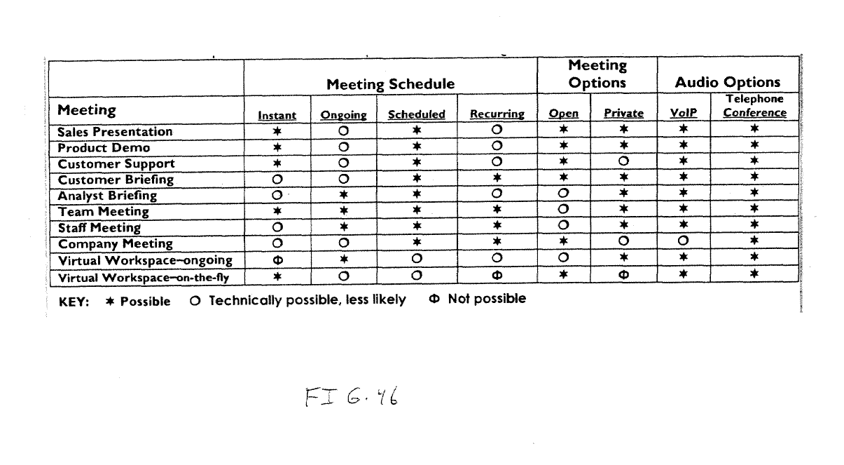

In one embodiment, instant meetings may be launched in different ways, such as a menu or tool bar icon. FIG. 43 is a screen shot illustrating an instant meeting launched from a menu, namely a “meet now” request. In this example, the user interface is integrated with a Skype browser. FIG. 44 illustrates that a request for an instant meeting opens up a user interface that permits a topic to be input and which also has a list of contacts. In this example, there are several ways that presence may be indicated. One way is to limit the list of displayed contacts to only those that are present (i.e., available for a meeting). However, as illustrated in FIG. 44, another way to indicate presence and availability status is to change the style of the icon used for contacts that are unavailable (note the slight difference in the icons used for several of the contacts). The user then selects a set of contacts to invite to the instant meeting. FIG. 45 illustrates an exemplary invitation sent out to the selected invitees to join in an instant meeting. In this example of a Skype-compatible embodiment, invitees join the meeting through a Skype-based audio connection. However, more generally it will be understand that an instant meeting may be applied with a variety of audio options.

Embodiments of the present invention permit many different meeting options. FIG. 46 is a table illustrating some exemplary meeting scenarios for different types of meetings, meeting options, audio options, and virtual workspaces in accordance with one embodiment of the present invention. To further illustrate the utility, ease of use, and productivity gains associated with using a meeting center, several scenario based descriptions are now described. Scenario A is an round-the-clock “Key Account Strategy Room.” In this scenario, suppose that you are part of a sales team tasked with landing new business in a big account by the end of the quarter. You want to create a “Virtual War Room” for the team in which you will meet, share documents, brainstorm, keep notes, and gain round-the-clock access to relevant content teammates place there. In one implementation, you would create a meeting that is ongoing and private; choose an audio option for meetings held in the workspace (if any) and invite attendees via their email addresses. Attendees can access this virtual workspace as they need to even if the host is not logged in to the workspace. Scenario B is product training for customers. In this scenario, you are an account manager who wants to train an existing customer on a new product feature. You would create a scheduled meeting with a specific date, time, and duration, decide how strictly you wish to control access and choose open or private, choose an integrated audio option, and then invite attendees via their email addresses. The host has access to the meeting as soon as it is created. Attendees are permitted to enter a pre-selected time (e.g., 10 minutes) before the meeting start time. Scenario C is regular meetings with geographically dispersed teams. You want to meet regularly with your staff or a project team. Staff and project team members all work from different locations. You create a recurring meeting with specific recurrence parameters including start time, duration, and frequency, make your meeting private to most strictly control access, choose an integrated audio option, and invite attendees via their email addresses. In this example, The host has access to the meeting as soon as it is created. Attendees are permitted to enter a pre-selected time (e.g., 10 minutes) before the meeting start time. In scenario D you take a conversation to online collaboration—instantly. In this scenario you are in a conversation—on the phone, on the Internet via Skype™, or in the hallway at the office—which could easily escalate into an online collaboration session. So you launch an Instant Meeting, giving your meeting attendees the appropriate meeting keys and the destination URL. You then begin collaborating instantly.

Embodiments of the present invention may be used in a variety of ways to improve collaboration. Presence, for example, improves the capability to setup meetings, such as instant meetings, with others. This is facilitated by the capability to aggregate contact information and friends lists from multiple source and by a universal presence aggregator. The variety of audio options permits users the capability to select a conventional conference telephone bridge or VoIP. The option to use VoIP when possible, reduces costs while supporting conventional telephone bridge is a useful option to support, for example, large scale meetings or user preferences. Meetings to be selected of different types, such as instant, ongoing, scheduled, or recurring. A virtual workspace may be created for a meeting to maintain and access centralized documents, an post updates using an integrated notes and polling feature. Thus some of the different capabilities that are supported included the capability to share applications or desktop; transfer and share documents; draw on a collaborative whiteboard; co-browse the Web and online media; chat with one or many; poll attendees and share results, bridge incoming standard phone and VoIP voice stream; maintain workspace content indefinitely; schedule meetings and send invitations; and archive meeting details with persistent storage. Moreover, the capability of users to dynamically switch between different client devices while maintaining presence (e.g., from desktop computer to a cell phone) during a meeting provides new options for fitting in meetings in busy schedules. Additionally, lifecycle management supports generating an audit trail, providing many benefits to enterprises to manage meetings throughout a lifecycle of a project having one or more meetings. Moreover, it will be understood that combinations of the above-described features can be used together to vastly improve meeting productivity over the prior an solutions.

It will also be understood that one embodiment of the present invention supports setting up meeting for business process. In one implementation the meeting platform exposes interfaces so that when a controller reaches a “meeting node” in a business process the controller automatically sets up a meeting using the meeting template with the appropriate user. When the meeting ends, the “outcome,” is returned to the business process engine so that it can continue the business process.

Glossary

| | |
|---|---|
| Convenos Meeting | Set of technology components and |
| Platform | application frameworks for building |
| | products. |
| Convenos Meeting | Product built using the Convenos Meeting |
| Center | Platform and delivered as a hosted |
| | application. |
| Convenos Meeting | Product built using the Convenos Meeting |
| Enterprise | Platform and delivered as a packaged product |
| | to enterprises. |
| Convenos Meeting | Product built using the Convenos |
| Appliance | Meeting Platform and delivered as an |
| | appliance. |
| XMPP | Extensible Messaging and Presence Protocol |
| | (previously called Jabber). A standard for |
| | exchanging messages of any type between |
| | two applications. Used in Google Talk and |
| | Apple iChat. |
| SIP | Session Initiation Protocol. A protocol |
| | originally designed to create a session for |
| | VoIP between two end points. |
| SIMPLE | Extension to SIP to support Presence and |
| | Instant Messaging. |

An embodiment of the present invention relates to a computer storage product with a computer-readable medium having computer code thereon for performing various computer-implemented operations. The media and computer code may be those specially designed and constructed for the purposes of the present invention, or they ma be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method of facilitating conferencing and collaboration of individuals with each individual having associated contact information, the method comprising:
monitoring presence information associated with a set of client devices utilized by a set of contacts, each client device being a device providing a capability to participate in a virtual meeting when in communication with a server via at least one communication service, each contact having at least one type of client device with the universe of communication services having at least two different representations of presence information;
aggregating different types of presence information for the set of contacts;
determining a current availability status for each contact to participate in a virtual meeting; and
providing information for displaying presence information indicative of the current availability status of each contact for the virtual meeting.

2. The method of claim 1, wherein the universe of communication services includes a set of instant messaging services and a set of voice over internet protocol (VoIP) services.

3. The method of claim 1, wherein the set of client devices includes desktop computers, cell phones, and handheld personal digital assistants.

4. The method of claim 1, further comprising:
monitoring buddy lists of a plurality of different types of buddy lists associated with the client devices, with each buddy list having an associated format;
transforming the buddy lists to a generic representation of a buddy list; and
using the generic representation of a buddy list to determine availability of contacts across different types of client devices.

5. The method of claim 4, wherein the different types of buddy lists include buddy lists from a plurality of different types of instant messaging services and Voice over Internet Protocol (VoIP) services.

6. The method of claim 1, further comprising:
storing profiles for each contact, each profile specifying at least one rule to define the current availability status; and
basing the current availability status at least in part on the rules of stored profiles.

7. The method of claim 6, wherein a stored profile for a contact defines rules that specify availability status based on the type of client device that is in communication with the server.

8. The method of claim 6, wherein a stored profile for a contact defines rules that specify availability based on at least one of: a time of day, a role, and a context.

9. The method of claim 1, wherein said displaying presence information further comprises displaying information on the type of device a contact is using.

10. The method of claim 1, further comprising utilizing presence information to display a list of invitees participating at the virtual meeting.

11. The method of claim 1, further comprising, using presence information to format virtual meeting information into a format compatible with the types of client devices used by each participant.

12. The method of claim 1, further comprising:
in response to request received from a client device, dynamically changing a point-of-presence associated with a contact from a first client device to a second client device.

13. The method of claim 1, further comprising aggregating multiple points of presence associated with different types of client devices into a single point of presence for a contact.

14. The method of claim 1, wherein displaying presence information includes generating a unique identifier for a contact and an availability status indicating whether the contact is available or unavailable.

15. A system to facilitate conferencing and collaboration, comprising:
a presence module to aggregate presence information from different types of communication services and generate an indicator of the current availability of a set of contacts for virtual meetings;
an audio conference server to support both voice over internet (VoIP) conferencing and conferencing via public switched telephone network (PTSN);
a digital content server to support sharing and archiving of digital content associated with virtual meetings; and
a platform providing lifecycle management for virtual meetings through a collaboration lifecycle including setting up at least one virtual meeting for a project and providing audio conferencing services and digital content services for each virtual meeting of the project.

16. The system of claim 15, further comprising application modules to support shared browsing, a whiteboard, a notepad, content sharing, instant messaging chat, data conferencing, audio conferencing and video conferencing.

17. The system of claim 15, further comprising a meeting administration application module to administer meetings, the meeting administration application module configured to support instant meetings, ongoing meeting, recurring meetings, and scheduled meetings.

18. The system of claim 15, wherein said component platform maintains a virtual workspace for meetings in which digital content associated with the project is maintained throughout the collaboration lifecycle.

19. The system of claim 18, wherein the digital content includes instant messaging generated during meetings.

20. The system of claim 18, wherein the digital content includes polls conducted during meetings.

21. The system of claim 18, wherein the digital content includes at least one blog associated with a project.

22. The system of claim 15, wherein the system generates a list of participants in a meeting based on presence information.

23. The system of claim 15, wherein the platform includes a searchable, auditable, reportable, and archivable (SARA) module to generate an audit trail for meetings.

24. A method of facilitating conferencing and collaboration, comprising:
at a client device, displaying generic presence information for a set of contacts, the generic contact information indicating the current availability of each contact using at least one type of communication service where the generic presence information is based on an aggregation of different types of presence information.

25. The method of claim 24, further comprising: at the client device, receiving a selection of contacts to be invited to a virtual meeting.

26. The method of claim 24, further comprising: providing a user interface at the client device to select an instant meeting.

27. The method of claim 26, wherein in response to a user input to select the instant meeting the generic presence information is displayed to select invitees to the instant meeting.

28. The method of claim 24, wherein the generic presence information is displayed as a list of attendees to a virtual meeting.

29. The method of claim 24, wherein the generic presence information is based on presence information from a set of instant messaging services and a set of voice over internet (VoIP) services.

30. The method of claim 24, wherein the generic presence information is based on presence information from desktop computers, cell phones, and personal digital assistants.

31. The method of claim 24, further comprising display ing a listing of documents on the client device during a meeting that are accessible by the client device.

32. The method of claim 24, further comprising displaying a poll at the client device during a meeting.

33. The method of claim 24, further comprising displaying instant meeting chat at the client device during a meeting.

34. A method of facilitating conferencing and collaboration, comprising:
at a client device, displaying a list of attendees to a virtual meeting based on presence information;
at the client device, providing a polling feature for a user to input polling information;
at the client device, providing a text window for the user to review instant messaging chat associated with the virtual meeting; and
at the client device, providing a window to display digital content associated with the virtual meeting.
